(19) United States
(12) Patent Application Publication
(10) Pub. No.: US 2009/0163183 A1
(43) Pub. Date: Jun. 25, 2009

(54) RECOMMENDATION GENERATION SYSTEMS, APPARATUS AND METHODS

(76) Inventors: Hugh O'DONOGHUE, Dublin (IE); Sean CORRIGAN, County Meath (IE); Shane CROWE, Dublin 4 (IE); Andrew PEGUM, County Dublin (IE); Kurt David LILLYWHITE, Hertfordshire (GB)

Correspondence Address: QUALCOMM INCORPORATED, 5775 MOREHOUSE DR., SAN DIEGO, CA, 92121, US

(21) Appl. No.: 12/237,864

(22) Filed: Sep. 25, 2008

Related U.S. Application Data
(60) Provisional application No. 60/997,570, filed on Oct. 4, 2007.

(51) Int. Cl. H04M 3/42; H04W 4/12; H04L 12/58

(52) U.S. Cl. 455/414.1; 455/466; 455/412.1

(57) ABSTRACT

A method for generating recommendations for a user of a mobile device is provided. The user is associated with a service provider. A request for a recommendation is obtained. Data associated with the user and data on the content available to the user is retrieved from the service provider. A list of recommendations is generated based on an analysis of the retrieved user data. The recommendations are generated by a plurality of different recommendation techniques.

### CLAIM OF PRIORITY UNDER 35 U.S.C. §119

The present Application for patent claims priority to Provisional Application No. 60/997,570 entitled RECOMMENDATION GENERATION SYSTEMS, APPARATUS, AND METHODS filed Oct. 4, 2007, and assigned to the assignee hereof and hereby expressly incorporated by reference herein.

### BACKGROUND

The present disclosure relates to a mobile operating environment, and more particularly to providing improved methods of generating recommendations to users of a mobile device carrier.

Mobile operators or mobile device carriers play a major part in the telecommunication industry today. Initially, such mobile operators concentrated their efforts on generating revenue by increasing their subscriber base. However, it will be appreciated that in several countries the scope for increasing the subscriber base has now become very limited, as the market has reached close to saturation point. As a result, the mobile operators have been branching into providing value added services to subscribers, in order to increase their revenue.

One means of generating increased revenue is through the sales of premium services to users, such as ringtones, wallpaper, Java games, etc. These services may be provided by the mobile operator themselves, or by business entities who may operate in collaboration with the mobile operators to provide such services. The services may be available for download to a user's mobile device upon payment of a fee.

Many benefits such as maximizing the potential earnings for sales accrue upon recommending and promoting to users content or services, which are most likely to be of interest to the users.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

To the accomplishment of the foregoing and related ends, the one or more aspects comprise the features hereinafter described and particularly pointed out in the claims. The following description and the annexed drawings set forth in detail certain illustrative aspects of the one or more aspects. These aspects are indicative, however, of but a few of the various ways in which the principles of various aspects can be employed and the described aspects are intended to include all such aspects and their equivalents.

In one aspect, provided is a method for generating recommendations for a user of a mobile device, the user associated with a service provider. A request for a recommendation is obtained. Data associated with the user and data on the content available to the user is retrieved from the service provider. A list of recommendations is generated based on an analysis of the retrieved user data, wherein the recommendations are generated by a plurality of different recommendation techniques.

In another aspect, provided is a computer program product having computer-readable storage medium with instructions. At least one instruction causes a computer to obtain a request for a recommendation. At least one instruction causes a computer to retrieve data associated with the user and data on the content available to the user from the service provider. At least one instruction causes a computer to generate a list of recommendations based on an analysis of the retrieved data, wherein the recommendations are generated by a plurality of different recommendation techniques.

In an additional aspect, provided is a system for generating recommendations for a user of a mobile device, the user associated with a service provider. Means are provided for obtaining a request for a recommendation. Means are provided for retrieving data associated with the user and data on the content available to the user from the service provider. Means are provided for generating a list of recommendations based on an analysis of the retrieved data, wherein the recommendations are generated by a plurality of different recommendation techniques.

In another additional aspect, provided is a system for generating recommendations for a user of a mobile device, the user associated with a service provider. A profile module stores and processes data associated with the user. A catalogue module stores and processes content available to the user. A decision module, which is in communication with the profile module and the catalogue module, generates a list of recommendations for the user by analysis of data retrieved from the profile and catalogue modules, wherein the recommendations are generated by a plurality of individual recommender modules.

In a further aspect, a method provides for generating promotions for a user of a mobile device. Attribute data and behavior data is accessed for a plurality of users of a corresponding plurality of mobile devices. Recommendations are generated for content to offer based on the attribute data and generating recommendations for content to offer based on the behavior data. A subset of recommendations is selected by applying a filtering constraint. The subset of recommendations is transmitted to at least a subset of the plurality of mobile devices.

In another further aspect, at least one processor generates promotions for a user of a mobile device. A first module accesses attribute data and behavior data for a plurality of users of a corresponding plurality of mobile devices. A second module generates recommendations for content to offer based on the attribute data and generating recommendations for content to offer based on the behavior data. A third module selects a subset of recommendations by applying a filtering constraint. A fourth module transmits the subset of recommendations to at least a subset of the plurality of mobile devices.

In a further additional aspect, a computer program product generates promotions for a user of a mobile device. A computer-readable storage medium comprises instructions. The computer readable storage medium includes at least one instruction for causing a computer to access attribute data and behavior data for a plurality of users of a corresponding plurality of mobile devices. The computer readable storage medium further includes at least one instruction for causing the computer to generate recommendations for content to offer based on the attribute data and to generate recommendations for content to offer based on the behavior data. Further included in the computer readable storage medium is at least one instruction for causing the computer to select a subset of recommendations by applying a filtering constraint. The computer readable storage medium further includes at least one instruction for causing the computer to transmit the subset of recommendations to at least a subset of the plurality of mobile devices.

In yet another additional aspect, an apparatus generates promotions for a user of a mobile device. Means are provided for accessing attribute data and behavior data for a plurality of users of a corresponding plurality of mobile devices. Means are provided for generating recommendations for content to offer based on the attribute data and for generating recommendations for content to offer based on the behavior data. Means are provided for selecting a subset of recommendations by applying a filtering constraint. Means are provided for transmitting the subset of recommendations to at least a subset of the plurality of mobile devices.

In yet a further aspect, an apparatus generates promotions for a user of a mobile device. A profile storage component contains attribute data and behavior data for a plurality of users of a corresponding plurality of mobile devices. A profile and recommendation system generates recommendations for content to offer based on accessed attribute data, generates recommendations for content to offer based on accessed behavior data, and selects a subset of recommendations by applying a filtering constraint. A network communication module transmits the subset of recommendations to at least a subset of the plurality of mobile devices.

### BRIEF DESCRIPTION OF THE DRAWINGS

FIG. 1 is a block diagram of a profiling and recommendation system of a mobile communication network, according to one aspect;

FIG. 2 is a timing diagram of a methodology of profiling and recommending, according to one aspect;

FIG. 3 is a block diagram showing an example wireless communication system incorporating the profile and recommendation system of the present disclosure, according to one aspect;

FIG. 4 illustrates a block diagram of a profile and recommendation system depicting a more detailed view of those components associated with the mobile operator which interface with the profile and recommendation system, according to another aspect;

FIG. 5A is a timing diagram for a methodology for profiling that interacts with external network entities;

FIG. 5B is a timing diagram for a methodology for an illustrative interaction of a wireless device with a category page generated by the profiling and recommendation system, according to one aspect;

FIG. 6 is a flow diagram of a methodology for accurate targeting of content by detailed understanding of subscribers' usage and interest, according to one aspect;

FIG. 7 shows a block diagram of the main components of the catalogue module; according to one aspect;

FIG. 8 shows a block diagram of the main components of the profile module; according to one aspect;

FIG. 9 is a schematic diagram which shows the four phases of the recommendation generation process in a decision module along with a flow diagram of a methodology for generating recommendations, according to one aspect;

FIG. 10 illustrates a flow diagram of a methodology summarizing the main operations for generating recommendations, according to still another aspect;

FIG. 11 illustrates a flow diagram of a methodology of sub-operations of the methodology of FIG. 10, according to yet another aspect;

FIG. 12 illustrates a flow diagram of a methodology of sub-operations involved in the methodology of FIG. 11, according to still another aspect;

FIG. 13 shows a block diagram of a relationship between recommender modules and a decision controller, according to one aspect;

FIG. 14 shows a flow diagram of a methodology for recommender processing, according to one aspect;

FIG. 15 shows an example diagram of various function calls in a Decision Recommender, according to another aspect;

FIG. 16 shows a block diagram of main components of the Decision Module, according to one aspect;

FIG. 17 shows a block diagram of the main components of a network recommender, according to one aspect;

FIG. 18 illustrates a flow diagram for network recommending, according to one aspect;

FIG. 19 is a diagram that illustrates how the Decision module meets performance requirements using a number of different techniques, according to one aspect;

FIG. 20 shows a block diagram of main components of a promote module, according to one aspect;

FIG. 21 shows a flow diagram of a methodology performed by the promotion module, according to another aspect;

FIG. 22 details more modules of the profile and recommendation system of FIG. 4, according to yet another aspect;

FIG. 23 illustrates a flow diagram of a computing platform for performing at least a portion of a methodology of profile and recommendation, according to one aspect; and

FIG. 24 illustrates a network device having modules for performing a methodology of profile and recommendation, according to one aspect.

### DETAILED DESCRIPTION

Various aspects of the disclosure are further described below. It should be apparent that the teaching herein can be embodied in a wide variety of forms and that any specific structure or function disclosed herein is merely representative. Based on the teachings herein one skilled in the art should appreciate that an aspect disclosed herein can be implemented independently of other aspects and that two or more of these aspects can be combined in various ways. For example, an apparatus can be implemented or a method practiced using any number of the aspects set forth herein. In addition, an apparatus can be implemented or a method practiced using other structure or functionality in addition to or other than one or more of the aspects set forth herein. As an example, many of the methods, devices, systems, and apparatuses described herein are described in the context of providing dynamic mobile coupons in a mobile communication environment. One skilled in the art should appreciate that similar techniques could apply to other communication environments as well.

As used in this disclosure, the term “content” is used to describe any type of application, multimedia file, image file, executable, program, web page, script, document, presentation, message, data, meta-data, or any other type of media or information that may be rendered, processed, or executed on a device.

As used in this disclosure, the terms “component,” “system,” “module,” and the like are intended to refer to a computer-related entity, either hardware, software, software in execution, firmware, middle ware, microcode, or any combination thereof. For example, a component can be, but is not limited to being, a process running on a processor, a processor, an object, an executable, a thread of execution, a program, or a computer. One or more components can reside within a process or thread of execution and a component can be localized on one computer or distributed between two or more computers. Further, these components can execute from various computer readable media having various data structures stored thereon. The components can communicate by way of local or remote processes such as in accordance with a signal having one or more data packets (e.g., data from one component interacting with another component in a local system, distributed system, or across a network such as the Internet with other systems by way of the signal). Additionally, components of systems described herein can be rearranged or complemented by additional components in order to facilitate achieving the various aspects, goals, advantages, etc., described with regard thereto, and are not limited to the precise configurations set forth in a given figure, as will be appreciated by one skilled in the art.

Additionally, the various illustrative logics, logical blocks, modules, and circuits described in connection with the aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the operations or actions described herein.

Furthermore, various aspects are described herein in connection with a mobile device. A mobile device can also be called a system, a subscriber unit, a subscriber station, mobile station, mobile, mobile device, cellular device, multi-mode device, remote station, remote terminal, access terminal, user terminal, user agent, a user device, or user equipment, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

Moreover, various aspects or features described herein can be implemented as a method, apparatus, or article of manufacture using standard programming or engineering techniques. Further, the operations or actions of a method or algorithm described in connection with the aspects disclosed herein can be embodied directly in hardware, in a software module executed by a processor, or in a combination of the two. Additionally, in some aspects, the operations or actions of a method or algorithm can reside as at least one or any combination or set of codes or instructions on a machine-readable medium or computer readable medium, which can be incorporated into a computer program product. Further, the term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, various storage media described herein can represent one or more devices or other machine-readable media for storing information. The term “machine-readable medium” can include, without being limited to, wireless channels and various other media capable of storing, containing, or carrying instruction, or data.

In addition to the foregoing, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Furthermore, as used in this application and the appended claims, the term “or” is intended to mean an inclusive “or” rather than an exclusive “or.” That is, unless specified otherwise, or clear from context, “X employs A or B” is intended to mean any of the natural inclusive permutations. That is, in this example, X could employ A, or X could employ B, or X could employ both A and B, and thus the statement “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or deducing states of a system, environment, or user from a set of observations as captured via events or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events or data. Such inference results in the construction of new events or actions from a set of observed events or stored event data, whether or not the events are correlated in close temporal proximity, and whether the events and data come from one or several event and data sources.

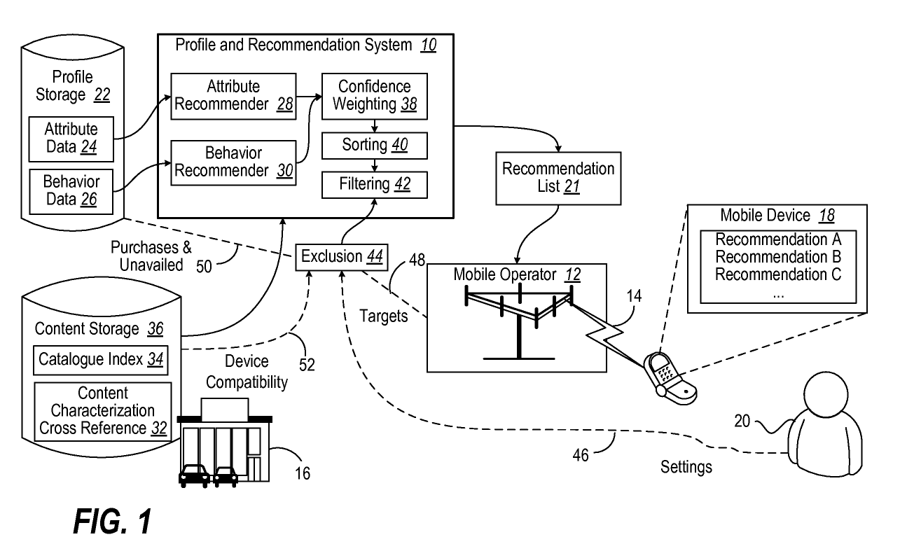

With reference to FIG. 1, the present aspects provide a profile and recommendation system 10 that enables mobile operators 12 of a wireless communication network 14 and their business partners, depicted as content providers 16, to proactively promote the uptake of content and services to their subscriber base, depicted as a mobile device 18 of a subscriber 20. In one example, this is achieved by the generation of a list of recommendations 21 tailored for the particular subscriber 20 for delivery to their mobile device 18. The recommendations can be displayed either on the portal associated with the mobile operator, or be delivered to the mobile device by mobile messaging, for example.

According to one aspect, stored profile data 22 comprises attribute data 24 or behavior data 26. A corresponding plurality of recommenders, depicted as an attribute recommender 28 and a behavior recommender 30 associate the respective data 24, 26 with content characterization cross reference 32 of a catalogue index 34 of content 36. Preliminary recommendations from the recommenders 28, 30 have a confidence level assigned by a confidence weighting component 38. For example, a weak or strong association may be determined. As another example, an attribute or behavior may be weakly determined through inferential analysis of limited occurrences or be a strongly determined through explicit inputs or repeated behaviors. The weighted preliminary recommendations can then be sorted by a sorting component 40.

Prior or subsequent to sorting, a filtering component 42 implements an exclusion 44 to avoid an inappropriate recommendation. Exclusions can be expressly specified by the subscriber 20 as depicted at 46, such as restricting certain categories of recommendations that would be objectionable. Exclusions can be specified by the mobile operator 12 as depicted at 48, such as specifying computing platform targets suitable for the content (e.g., audio files suitable for a mobile device with an MP3 media player). Exclusions can also be drawn from profile data 22 depicted at 50, such as tracking of purchases of content that would otherwise be recommended again or recommendations repeatedly ignored by the subscriber 20. Exclusions can also be drawn from content providers 16, which can be the mobile operator 12, by providing device or software configuration compatibility information 52. Thereby, mobile devices 18 that cannot successfully use recommended content are excluded.

The recommendations are generated by an analysis of the subscriber information available to the mobile operator in conjunction with the content and services offered, so as to determine those content and services, which are likely to be of the most interest to the subscriber. In particular, the profile and recommendation system 10 also enables the recommendations to be delivered to the subscriber 20 at those times which have been determined to be when the subscriber 20 is most amenable to purchasing based on attribute or behavior assessment as an individual or group member. The profile and recommendation system is also adapted to generate promotions, when it is desired to actively promote a particular content or service to its subscriber base.

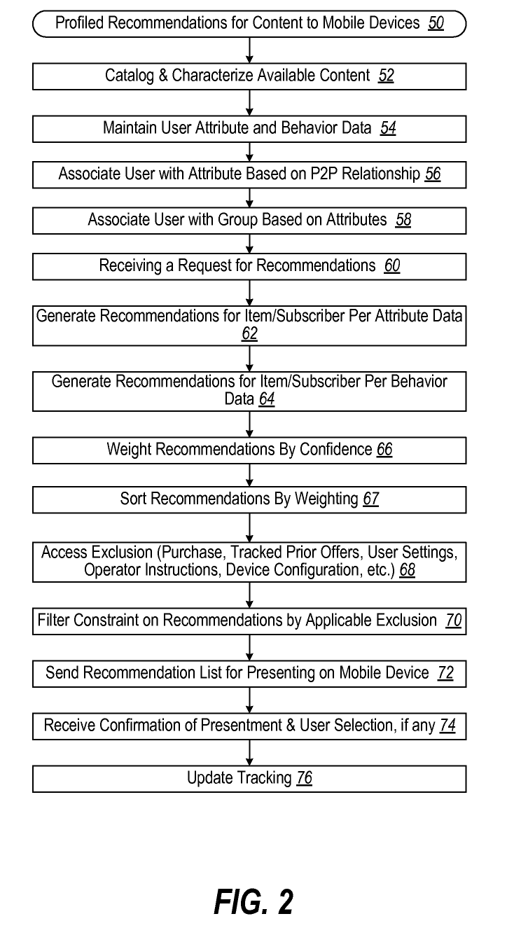

In FIG. 2, a methodology 50 is depicted for profiled recommendations of content for offering on a mobile device, according to one aspect. In block 52, available content is catalogued and characterized. In block 54, user attributes and behavior data is maintained. In block 56, association can be made for a user with an attribute based on peer-to-peer (P2P) relationship with a user for whom the attribute was previously determined. This indirect association can have a lower weighting than an association made from express or direct information. In block 58, a user can be associated with a group, such as explicit enrollments, frequent accessing of a portal for a group, etc. This associated group can have attribute and behavior data that can then be used for the associated user, especially in instances where insufficient data has been received specific to the associated user. In block 60, a request for recommendations is received. In block 62, recommendation requests to obtain an item for a subscriber or subscribers for an item are generated per the attribute data. In block 64, recommendation requests to obtain an item for a subscriber or subscribers for an item are generated per the behavior data. The recommendations are weighted by assigning a confidence level to each (block 66). The weighted recommendations are sorted so that a highest subset can be delivered (block 67). Exclusions are accessed, such as prior purchase, tracked prior offers, user settings (restrictions), operator instructions, device compatibility/configuration, etc. (block 68). In block 70, recommendations are filtered by accessing an applicable exclusion. In block 72, the filtered and sorted recommendations are sent for presenting on a mobile device. In block 74, confirmation is received of presentment of the recommendations and any user selection. With this data, tracking is updated (block 76).

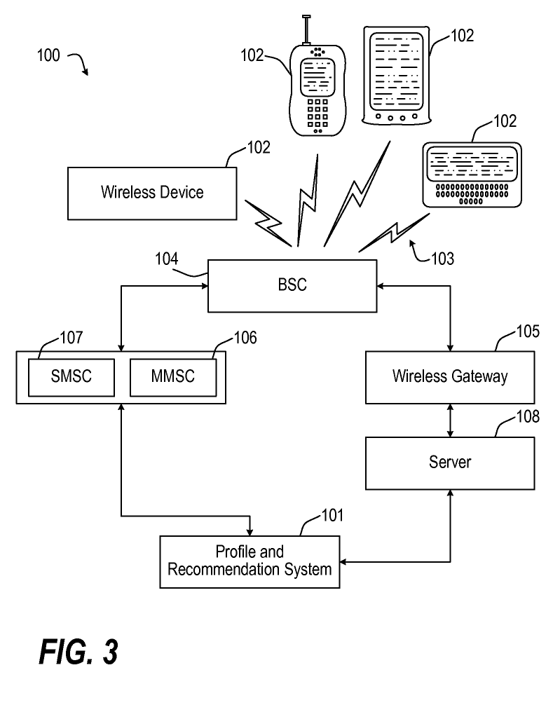

Referring now to FIG. 3, according to one aspect, a block diagram showing an exemplary wireless communication system 100 incorporating the profile and recommendation system 101 of the present disclosure is provided. The wireless communication system 100 may include one or more wireless devices 102, which communicate over a wireless network 103 with a base station controller (BSC) 104. The wireless devices 102 can be of any suitable type, including for example a handheld PC, a PDA, or a mobile phone. The base station controller 104 in turn communicates with a mobile operator's communications infrastructure, such as, for example, a wireless gateway, depicted as a Wireless Application Protocol (WAP) gateway 105, multimedia message switching centre (MMSC) 106, and short message switching centre (SMSC) 107. The mobile operator's systems also includes a server 108 configured to act as a portal.

In one instance, the profile and recommendation system 101 of the present disclosure is communicatively linked with the mobile operator's communications infrastructure. In one example, the profile and recommendation system enables the mobile operator and associated business partners to proactively promote the uptake of services, by providing a unified view and advanced profiling of their subscriber base, as well as intelligent recommendations, as will be explained in more detail below.

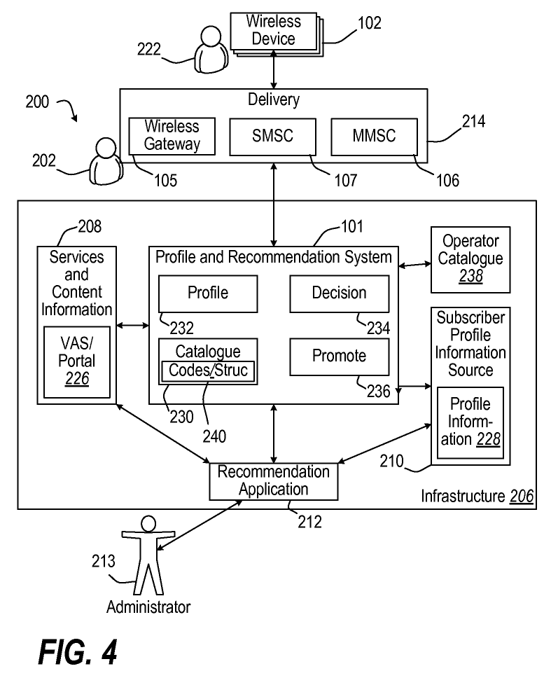

According to one aspect, FIG. 4 shows an exemplary block diagram of a profile and recommendation network 200 showing interactions between certain components associated with a mobile operator 202 and a profile and recommendation system 101 of the present disclosure. These systems may be directly integrated in a mobile operator's communications infrastructure 206, or alternatively may be part of a system of a business partner associated with the mobile operator. The infrastructure 206 can include a services and content information component 208, a subscriber profile information source 210, and a recommendation application 212 used by an administrator 213. The profile and recommendation system 101 interfaces with content delivery system 214, which can comprise a WAP gateway 105, Short Message Service Centre (SMSC) 107, and Multimedia Messaging Service Centre (MMSC) 106 and which in turn communicates with wireless devices 102. The content delivery system 214 provides content delivery capability via connection to network systems such as WAP gateways 105, SMSCs 107, MMSCs 106. This enables the profile and recommendation system 101 to deliver and receive any type of mobile content or service to users or subscribers 222 of wireless devices 102 in communication with the content delivery system 214. This capability can be implemented where the profile and recommendation system 101 is used to deliver promotional information (e.g., via SMS, MMS, WAP Push, etc.) and where the profile and recommendation system 101 is responsible for content delivery fulfillment (e.g., polyphonic ringtone, wallpaper, games, etc.).

The services and content information component 208 can comprise external platforms such as Value Added Services (VAS) or portal 226 with which the profile and recommendation system 101 can communicate. In one example, integration with VAS platforms 226 can facilitate the creation of a complete catalogue of content available to the mobile subscriber 222 of one or more wireless devices 102. This allows the profile and recommendation system 101 to more intelligently retail the available content or services on offer by a mobile operator or its partners. Integration with portal 226 enables the delivery of targeted promotions to those users or subscribers 222 that use the portal 226, and enables the capturing of information component 228 about their behavior for later referencing from the subscriber profile information source 210. In one instance, the subscriber profile information 228 includes one or more of call data; gender; date of birth; prior purchases; expressions of interest or disinterest; spending pattern; mobile device type, current geographical location, call frequency or other metadata.

FIG. 4 further provides details of illustrative main components of the profile and recommendation system 101, according to one aspect. These include a catalogue module 230, a profile module 232 a decision module 234 and a promote module 236. Each of these modules will be described in more detail below. The catalogue module 230 enables the profile and recommendation system 101 to be utilized as a central catalogue for a large amount of content or services. In this manner, a more detailed picture of the available content/services can be provided to other systems (e.g., a portal, etc.), thus enabling a better management of the content retailing process.

According to one example, operator catalogue 238 maintained by a mobile operator in a centralized location may include a complete catalogue of voice, data, and other services provided by the operator. In one instance, the catalogue module 230 can maintain the product ID codes and structures 240 that are defined in the mobile operator's central catalogue 238.

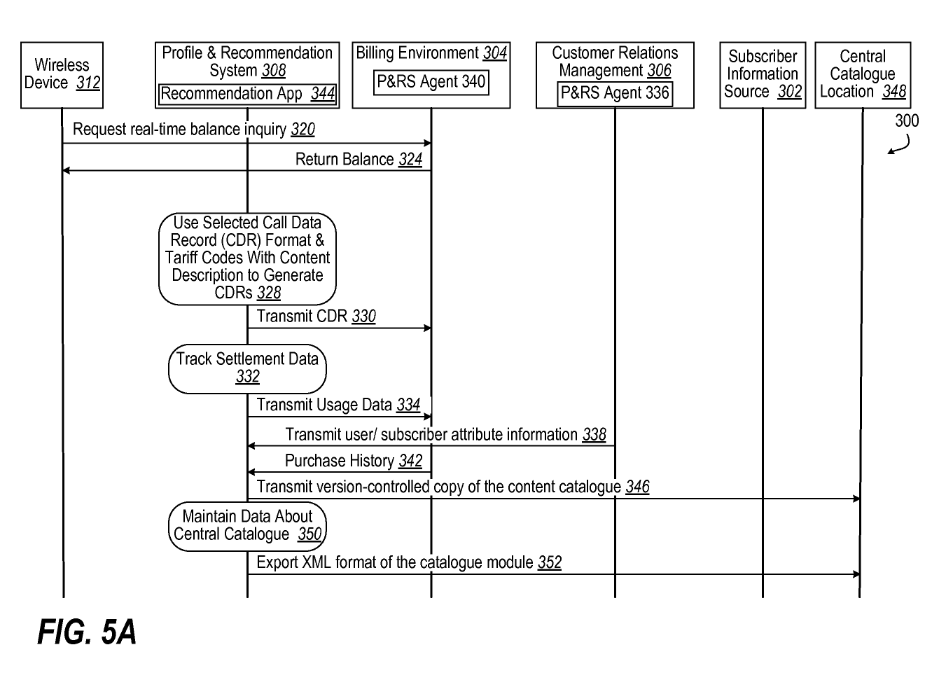

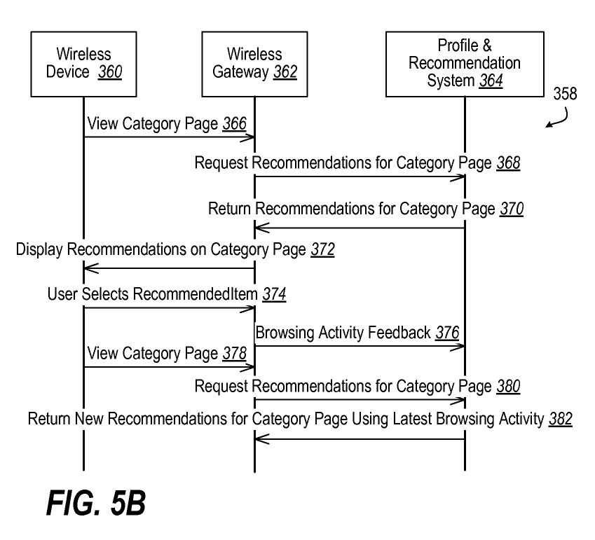

In use, as depicted in FIG. 5A, in one example, a methodology 300 for profiling and recommending interacts with external network entities, depicted as a subscriber profile information source 302. In turn, the subscriber profile information communicates with a mobile operator's existing billing system 304 and Customer Relationship Management (CRM) system 306. A profile and recommendation system 308 performs billing integration when responsible for content delivery to a user or subscriber wireless device 312.

In another aspect depicted in FIG. 5B, a methodology 358 illustrates a wireless device 360 accessing a wireless gateway 362 to receive recommendations on a category page generated by a profile and recommendation system 364. As depicted at 366, the wireless device 360 requests to view a category page from the wireless gateway 362, which in turn forwards a request for recommendations to the profile and recommendation system 364, as depicted at 368. Recommendations are generated and returned to the wireless gateway 362, as depicted at 370, which in turn displays the recommendations on the category page on the wireless device 360, as depicted at 372. When a user selects a recommended item on the category page, this selection is communicated to the wireless gateway 362 as depicted at 374. The wireless gateway 362 provides feedback of the browsing activity as depicted at 376 to the profile and recommendation system 364. The user of the wireless device 360 can request an additional view of the category page as depicted at 378 that is communicated to the wireless gateway 362. As depicted at 380, the wireless gateway 362 requests recommendations to populate the category page, which in turn responds as depicted at 382 with new recommendations for the category page that reflect the latest browsing activity, such as eliminating an item already purchased or offered more than a specified threshold or adding an item related to the selected recommended item.

Referring back to FIG. 5A, the profile and recommendation system 308 can support a range of billing scenarios as an application programming interface (API) to customer-specific billing systems 304. The wireless device 312 transmits a request for real-time information as depicted at 320 to the billing system 304, enabling real-time balance enquiries to be performed, purchase events, such as new subscriptions to be notified, and promotional balances to be utilized (e.g., for the first three months of a new contract, the subscriber can download two games a month free, etc.). The billing system 304 thus returns the information or transaction confirmation to the wireless device 312, as depicted at 324. The real-time nature of this API performed by the profile and recommendation system 308 ensures that pre-pay subscribers' balances are effectively managed and revenue leakage is minimized.

According to one example, as depicted in block 328, the profile and recommendation system 308 can use tariff codes in the generation of Call Data Records (CDRs) for billing purposes, which are transmitted to the billing system 304 as depicted at 330. These codes are user-defined and may be associated with all content from a content source. In one aspect, multiple CDR format outputs may also be supported by this interface. In addition to the basic tariff code information, it can also include descriptions of the actual content that can be included on the subscriber's bill. It can also manage billing tags for promotional information that have a zero or special rating. According to one implementation, as depicted in block 332, the profile and recommendation system 308 can also handle settlement data to help the mobile operator distinguish between pricing for actual content versus the bandwidth used to deliver the content, which is transmitted to the billing system 304 as depicted at 334. It can also differentiate between the wholesale price and the retail price to report on how much the mobile operator owes the content provider.

The profile and recommendation system 308 is further operable to enable multiple agents to either feed data into the profile module 232 (FIG. 4) or catalogue module 230 (FIG. 4). For example, it is possible to configure one agent 336 to receive user or subscriber attribute information as depicted at 338 from the CRM system 306 and another agent 340 to receive user or subscriber purchase history as depicted at 342 from the billing system 304.

A recommendation application 212 operates to provide the means by which the profile and recommendation system 308 can interface with an external application, through which all aspects of the profile and recommendation system 308 can be administered, such as for example promotional, catalogue and content management. In one aspect, this may be a web based user interface (not shown) available to administrators, which can be either the mobile operator's employees or its associated business partners, such as its content partners. The many features of this recommendation application 344 will be understood when described below with reference to the various modules of the profile and recommendation system 308.

At configurable time periods, as depicted at 346, a version-controlled copy of the content catalogue can be exported to a central catalogue location 348. In accordance with one aspect, the profile and recommendation system 308 maintaining data about the content in the central product catalogue at block 350 enables the profile and recommendation system 308 to export an XML format of the catalogue module 230 to the central catalogue location 348 as depicted at 352. In this manner, according to one example, all details are preserved and no issues with respect to re-indexing of the content may arise.

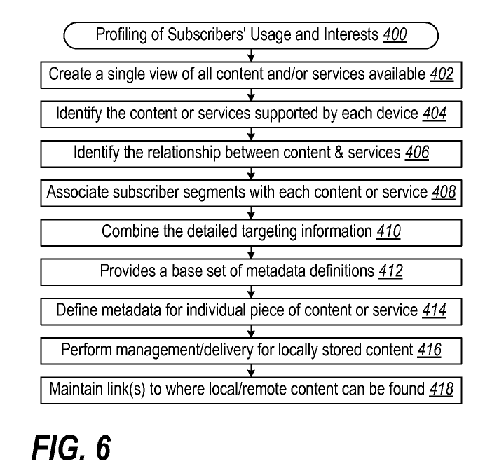

With reference to FIG. 6, in accordance with one implementation, a methodology 400 for profiling users or subscribers is facilitated through a detailed understanding of subscribers' usage and interests (built through the profile module 232 (FIG. 4)) and a detailed content catalogue. This detailed content catalogue is enabled through the definition of metadata. In one example, catalogue module 230 (FIG. 4) operates to create a single view of all content or services available across the mobile operators and the associated business partners (block 402). Additionally, the catalogue module 320 can operate to identify the content or services supported by each device (block 404). The catalogue module 320 can operate to further identify the relationship between content and services (block 406). Additionally, the catalogue module can operate to associate subscriber segments with each content or service (block 408). The catalogue module 230 further operates to combine the detailed targeting information (block 410) about which subscriber segments each content or service applies to, the relationships between content or service, and which devices support the content or service as well as usage information.

According to one example, the catalogue module 230 provides a base set of metadata definitions (block 412) and defines an additional unlimited range of metadata for each individual piece of content or service (block 414). The greater the range of metadata elements that are defined for content or service items, the more options there are in terms of grouping content or services (into asset groups) and for mapping content or services to users or subscribers with diverse interests. According to one non-limiting example, this metadata can specify, among other things, data volume, pricing information (retail and settlement), adult content, promotional tags, the location of content (stored locally or remotely), etc.

The catalogue module 230 can be implemented in situations where content or service metadata is stored, or where it additionally stores some or all of the content or service itself (e.g., ringtones, wallpapers, etc.). In the latter case, a content module may also be deployed which operates to perform management and delivery for the locally stored content (block 416). In one exemplary deployment wherein the content itself is not stored, catalogue module 230 operates to maintain one or more links to where the content can be found (block 418). In either case, timely and accurate population of content metadata enables the modules of the profile and recommendation system 101 (FIG. 4) to function effectively.

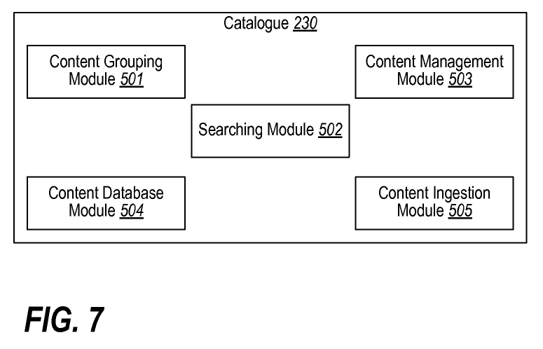

FIG. 7 shows a block diagram of the main components of a catalogue module 230, according to one aspect. These comprise a content grouping module 501, a searching module 502, a content management module 503, a content database module 504, and a content ingestion module 505. The functionality of each of these modules is explained in more detail below.

In one aspect, the content grouping module 501 can provide an asset grouping to a portal. Asset grouping enables pages to be built that are specific to a content theme and a user or subscriber's tariff and mobile device capabilities. The catalogue module 230 can automatically consolidate all content or services from multiple sources (example, e.g., a film, as a single asset group, etc.). In another example, there may be an asset group for female pop artists to which a Britney Spears ringtone belongs. There may also be an asset group for Britney Spears to which the same ringtone belongs, while the same ringtone may also belong to an asset group for top 10 ringtones. The creation of asset groups is based on groupings around metadata, and the range of asset groups to which a piece of content belongs. In one aspect, creation of asset groups for a content item by the content grouping module 501 may be restricted by the number of metadata tags defined for the content item.

According to one aspect, the searching module 502 provides a built-in search engine that provides content search capability based on keywords. The engine works by building a search index from the content metadata. It is possible to configure the exact metadata fields on which a search can be performed. For example, searching module 502 enables a search using commonly used search fields such as artist and title as well as other fields such as cost. The search index is updated at configurable periods from the catalogue data.

In one aspect, mobile device capability is an abstract mapping between a category of content and the devices supporting the content. For example, a device capability of “MMS 30K” could be used to track devices that support MMS messages to a 30 Kb limit. In one implementation, the profile and recommendation system 101 can operate to track which devices 102 support this capability and which items of content require this capability. It is then possible to query the catalogue module 230 by means of the searching module 502 for content that is supported by a particular device. In one instance, the latter can be achieved by the portal. In this manner, the user or subscribers are not offered content that is not compatible with their mobile devices. In addition, there might also be a device capability of “MMS 100K.” In one instance, wherein a device might have both capabilities, priority might be given to the most suitable capability, in this case the 100K version. According to one aspect, content information is retrieved by means of the content ingestion module 505. When information is being retrieved for a particular user or subscriber, the profile and recommendation system 101 will return the most suitable content for that user or subscriber's device.

When deployed with profile module 232, the profile and recommendation system 101 can track which content is the most popular within certain categories. This information can then be reported to the portal for the creation of categories such as “Top 10 Games” or “Top 10 Arcade Games.” If usage information is not available from profile module 232, then catalogue module 230 can have a content popularity rank specified explicitly. This can be from an external system that has this information, or can be set manually by the administrator 213. In one instance, the contents of the catalogue module 230 are stored in the content database module 504. This may be populated by communication between catalogue module 230 and the services and content information block 208 (e.g., a portal, etc.), for the retrieval of the available content or services. The recommendation application 212 enables the administrator 213 in the form of authorized users (e.g., content providers) to manage the metadata associated with content that the content provider adds to the catalogue module 230 by communication with the content management module 503. According to one example, an XML API is also provided that allows bulk uploading of content updates. Through these interfaces, the administrator 213 can build information about the content, such as where content is stored (e.g., locally or remotely, etc.), what price the content provider will charge for the content, etc. According to one example, the content provider can also build basic promotions, which allow the content provider to specify ways in which the content provider is willing to discount content or service to the mobile operator, users or subscribers. The interface can further provide real-time statistics on content usage, and content delivery status as well as subscriber activity.

When uploading catalogue data to the content database module 504, in one example, it may be possible to specify a catalogue zone. If specified, the catalogue zone(s) are then used to segment catalogue data into different partitions. In one example, the catalogue zone can be used to split content items into different areas so that recommendations will be returned for a particular subsection of content. For instance, all music content sources could be given the catalogue zone “Music” and all game content sources could be given the catalogue zone “Games.” When requesting a recommendation, a specific catalogue zone could be specified so as to only return recommended items from that catalogue zone (i.e., only get music recommendations by specifying a catalogue zone of “Music” or get only game recommendations by specifying a catalogue zone of “Games.”) In one example, specifying no catalogue zone would return recommendations from all catalogue zones (e.g., in this example, “Games” and “Music.”)

With continued reference to FIG. 4, the profile module 232 provides an active mechanism for profiling users' or subscribers' online behavior, segmentation, interests, likely spend patterns, device, birthdays, anniversaries, peak usage periods, etc. to enable one-to-one targeting of promotions and services. Profile module 232 provides the data required for the decision module 234 to make its intelligent recommendations. In one instance, the richer and more relevant the data contained in profile module 232, the better the recommendations.

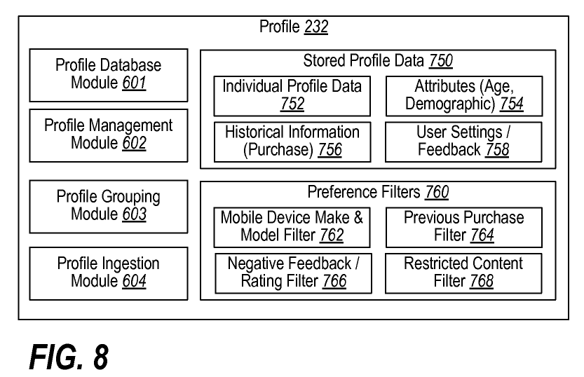

In another aspect, in FIG. 8 a block diagram of the main components of a profile module 232 comprise a profile database module 601, a profile management module 602, a profile grouping module 603 and a profile ingestion module 604. The functionality of each of these modules will be described in more detail below.

According to one example, by default, profile module 232 may include the metadata required to capture many of the most common user or subscriber details, both in terms of actual subscriber attributes (e.g., pre- or post-paid) and historic purchase information. Profile module 232 can additionally provide the ability to easily extend the default subscriber profile data model to meet specific needs.

With continued reference to FIGS. 4 and 8, in one example, by means of the recommendation application 212 in communication with the profile management module 602 the administrator 213 can define new metadata fields, respective data type, whether the new metadata fields are free-form or from a fixed list, and whether the new metadata fields are mandatory. The new metadata can then be utilized in the same manner as the default metadata in areas such as profile groups, decision, profile data import and export. In this manner, the administrator 213 can tailor the profile information to better suit the way in which the administrator 213 wants to use the system and process of importing/exporting profile data from external systems that have pre-existing metadata.

With particular reference to FIG. 8, the profile grouping module 603 further provides the functionality to create and manage profile groups based upon the information stored in the profile database module 601. In one example, these groups are comprised of users or subscribers with common attributes or purchase behavior. In one example, groups can be created by one or more of the following mechanisms: (A) Importing user or subscriber lists from a subscriber profile information source such as a CRM system. This can be a manual file import process or can be automated via the connect module; (B) Categorizing users or subscribers by a particular piece(s) of profile metadata (e.g., all male, pre-paid subscribers, etc.); (C) Analyzing the past usage of the system (e.g., subscribers that have purchased, or not purchased a particular piece or category of content, etc.); and (D) Categorizing subscribers by the types of device they have (e.g., MMS capable devices, etc.). According to one example, groups can be defined statically for a particular period of time (e.g., users or subscribers that purchased a Game in December 2004, etc.) or can be dynamic (e.g., users or subscribers that have not purchased a ringtone in the last month, etc.).

With continued reference to FIG. 4, in one example, profile groups may be useful in the following ways: (A) Online promotions wherein the promote module 236 can use profile groups to determine which subscribers should see a particular banner ad when the subscriber visits the portal. For example, a subscriber group could be created that contains all subscribers that have SMS alerts and an MMS capable mobile device 102. This would be used to offer MMS alert services to these users or subscribers 222 the next time the user or subscriber 222 visits the portal 226; (B) Outbound promotions wherein the promote module 236 can use profile groups to determine which users or subscribers 222 should be sent an outbound promotion via SMS, MMS, WAP Push, etc. For example, a subscriber group could be created that contains all users or subscribers 222 that have purchased “FIFA 2004.” This would be used to run an outbound promotion for “FIFA 2005”; (C) The details of profile groups can be exported to an external system to update a centralized system (e.g., a subscriber profile information source 210 such as CRM or data warehouse, etc.) and thus assist in the process of maintaining a consolidated subscriber database (not shown); and (D) Profile groups can be used in conjunction with promote campaigns to run interest groups where users or subscribers 222 can be opted-in to receive information about new promotions or services. In one example, promote module 236 will operate to automatically manage user or subscriber opt-in and opt-out.

In one example, it may also be possible to maintain a count of the number of contacts per subscriber and the user or subscriber's preferred contact method. According to one example, the latter may be required for regulatory reasons or under a mobile operator's customer contact policy. It can be used to ensure that users or subscribers with a wide range of interests are not bombarded with promotions in specific time frames. Recording the preferred contact method can ensure that promotions will be directed to a user or subscriber in a manner that is most likely to elicit a positive response.

According to one aspect, one of the functions of profile module 232 is the efficient storage of user or subscriber attributes and their purchase history in the profile database module 601 for later retrieval by means of the profile ingestion module 604, when required. In one instance, the storage mechanism is configured to be capable of storing large quantities of data in a manner that enables high performance data updates and data access. In one aspect, an Oracle relational database for the storage of all platform data, including profile data may be used. In another instance, a dedicated, but lightweight, data access layer that uses native Oracle connectivity APIs (e.g., Java Database Connectivity (JDBC), Oracle Call Interface (OCI), etc.) connects to the database in an efficient manner. In one instance, techniques such as executing operations through multiple database connections, using prepared Structured Query Language (SQL) statements, and intelligent data caching may also be used. The data access layer may encapsulate the specific storage mechanisms from other parts of the platform, providing a clean level upon which to build the profile functionality.

In addition, in one example, the extensible metadata feature of profile module 232 may require that the profile database module 601 be capable of managing these metadata definitions and their associated values. This capability may be provided via a metadata tag library that allows defining new metadata attributes with any system entity. In one example, the latter is used in conjunction with profile module 232 and catalogue module 230.

According to one aspect, profile data may originate either from external systems (e.g., the subscriber profile and information source block) or from information built up by the profile and recommendation system 101. Data from external systems may be fed into the profile database module 601 via a connect module (not shown in FIG. 4). In one aspect, the data may relate to user or subscriber attributes and may include usage information, where available.

In one implementation, the degree to which the profile and recommendation system 101 can populate the profile information, independently, may depend on the modules that have been deployed and the manner the modules have been used. For example, if the content module is used to deliver certain content or services, then usage information for these services may automatically be recorded in the profile database module 601. If the profile and recommendation system 101 (FIG. 4) is integrated with a services and content information component 208 (e.g., a portal 226, etc.) in such a way that the services and content information block reports user or subscriber purchases to the profile and recommendation system 101, such information can also be recorded.

In one example, when uploading the profile data to the profile database module 601, it may be possible to assign a profile zone to the data. If specified, according to one example, the profile zone(s) can then be used to segment user or subscriber transaction data into different partitions. According to one instance, profile zone may be used to split subscriber transactions into different partitions so that recommendations will be made using the data from a specific partition. For instance, if transaction data from two operators (e.g., Mobile Virtual Network Operator (MVNOs)) were uploaded to the system, then transactions from each operator may be given different profile zone values.

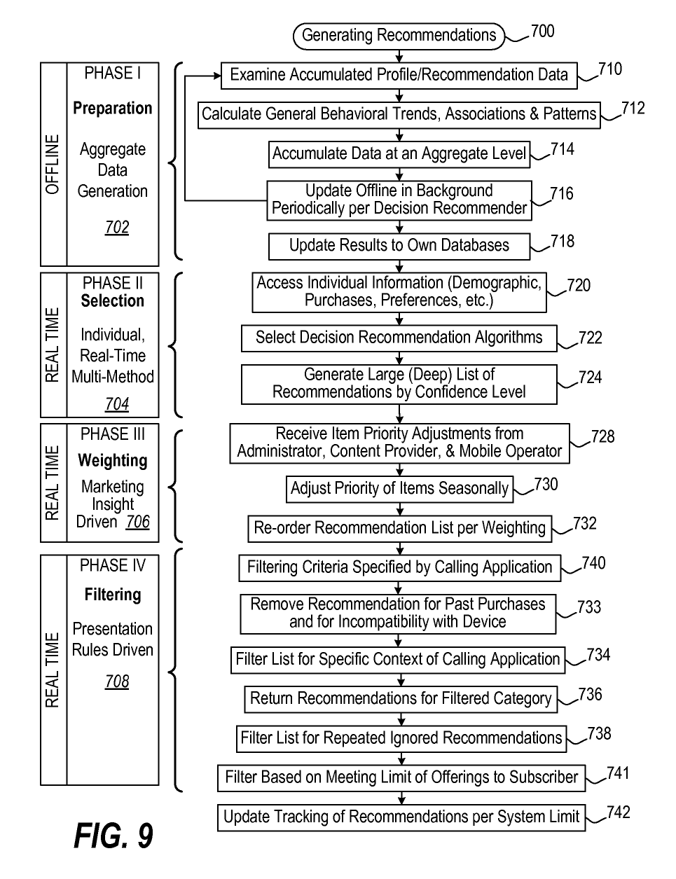

With reference to FIG. 9, according to one aspect, a methodology 700 for recommendation generation is depicted as having an offline Phase I that performs preparation (block 702) including aggregate data generation. The following three realtime processes include a Phase II that performs selection (block 704) for individual. A Phase III performs weighting (block 706) for insight driven marketing. A Phase IV performs filtering (block 708) for rules driven presentation.

With continued reference to FIGS. 4 and 8, during phase I “Preparation” processing, the decision module 234 would generate data for each profile zone individually, and a default zone that would combine all data. When requesting recommendations, the required profile zone can then be selected on a user interface (UI) or specified on an API call. If a Profile zone is not specified when requesting a recommendation by means of the profile ingestion module 604, then data from the default zone can be used.

The decision module 234 is used to recommend the best offer to users or subscribers. According to one implementation, the latter differs from the promote module 236, where the administrator 213 best offer selection mechanism uses a fixed number of predefined promotions and a number of pre-determined profile groups. According to one example, using the decision module 234, it is possible to automatically generate the most appropriate offer, without manual configuration.

With continued reference to FIG. 4, by making use of the decision module 234, and the unified view of the subscriber and content and data services available, an intelligent match of the most relevant content or service directly to an individual user or subscriber may be made, taking into account factors such as the wireless device 102 being used, the user or subscriber demographics, previous purchase behavior, how the user or subscriber's previous purchase behavior relates to other similar subscribers' buying habits, available funds, etc. This unique and broad range of decision criteria ensures that only relevant content is offered or presented to the user or subscriber 222.

The decision module 234 further utilizes the product information available from the catalogue module 230 with the subscriber information available from the profile module 232 to generate recommendations. According to one aspect, the more information that is made available to these modules, the better the recommendations that can be made by the decision module 234.

According to one aspect, the decision module 234 utilizes substantially all the information gathered by the catalogue module 230 and the profile module 232 to present relevant, interesting, and timely content or services and promotions to users or subscribers 222. The decision module 234 therefore brings self-learning capabilities that enable mobile operators to ensure they can substantially automatically maximize the sales opportunities every time a user or subscriber 222 uses the mobile operator's content or services.

In one or more nonlimiting aspects, the decision module 234 has a number of use cases: (A) Selection of the best promotion (as defined by promote module 236) for a subscriber when a subscriber accesses a portal and the profile and recommendation system 101 is asked to suggest the most appropriate promotion; (B) Selection of the content or service (as stored in catalogue module 230) for a user or subscriber, instead of a piece of content being selected by an explicitly created promotion. The latter removes the requirement for the administrator 213 to explicitly create promotions when a well-populated catalogue is available; (C) Selection of the best users or subscribers to target with a promotion. The latter is performed when selecting the target list of users or subscribers for an outbound promotion. In one example, the decision module 234 can identify the users or subscribers that the decision module 234 determines will respond positively to the promotion, with a minimum degree of certainty; (D) Selection of the best offer to make to a group of users or subscribers wherein the content or service to be offered is selected from the catalogue module 230 rather than a particular promotion. In one instance, starting with an identified group of users or subscribers 222, the decision module 234 identifies the best content item or service to offer each user or subscriber 222 from the catalogue module 230, choosing content items whose probability of eliciting a positive response is above a specified minimum; (E) The cross-selling of content or service based on already purchased items. The decision module 234 can use information about a subscriber's last purchase to identify another content item or service that should also be recommended to the user or subscriber 222. The content or service can then be recommended to the user or subscriber 222 on a portal or via an automated outbound promotion shortly after a purchase has been made.

With further reference to FIG. 9, a schematic diagram depicting the four phases of a recommendation generation methodology 700 in the decision module is provided, according to one aspect. The fours phases are Phase I—Preparation 702, Phase II—Selection 704, Phase III —Weighting 706, and Phase IV—Filtering 708.

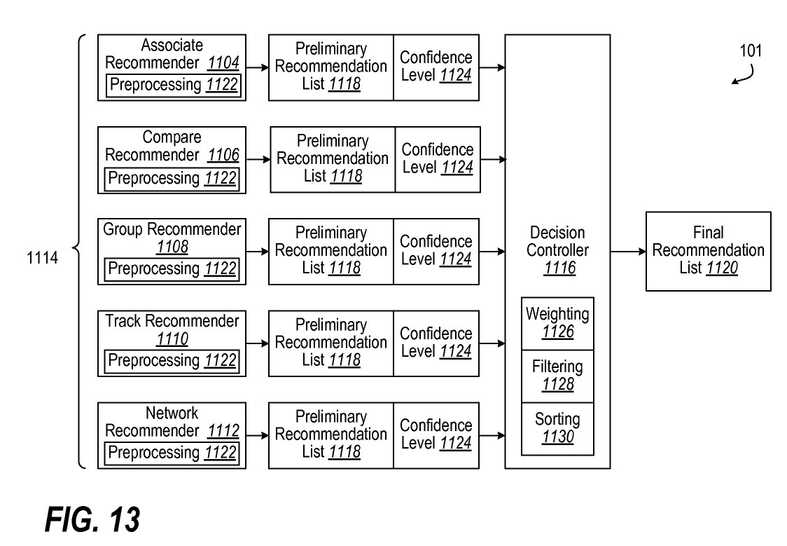

During Phase I (preparation portion 702 of the methodology 700), the data accumulated within the profile and recommendation system 101 and its associated business partners is examined (block 710) and general behavioral trends, associations, and patterns are calculated (block 712). In one example, in Phase I preparation methodology 702, data accumulation is performed at an aggregate level, as opposed to an individual level (block 714). Phase I preparation methodology 702 can be performed periodically in an offline/background process (block 716). The frequency at which Phase I 702 is performed may depend on how often the data is updated. As each decision recommender (algorithm) has its own preparatory phase, the decision recommenders can be tailored to execute at frequencies that suit each recommender. Additional information with respect to each decision recommender is provided below with respect to FIGS. 13-16. According to one illustrative example, output is made to their own databases (block 718). According to another example, the data may be accumulated within the profile and catalogue modules 232 and 230, respectively, from which the inputs were also drawn. One of ordinary skill in the art should appreciate that in a different aspect, data could be accumulated from any other suitable source.

During the Phase II selection portion 704 of methodology 700, the decision module 234 can access specific information about the individual (e.g., demographic, past purchases, preferences, etc.) (block 720) and the decision module recommendation algorithms select recommendations (block 722) for an individual user or subscriber. In one instance, decision module 234 can generate a large (deep) list of recommendations ordered by confidence level (block 724).

During the Phase III weighting methodology 706, the decision module 234 can provide the administrator 213, content provider, or mobile operator with the ability to specify the items that should be prioritized/de-prioritized in terms of the likelihood to be recommended to a user or subscriber (block 728). In one exemplary use case, it may be desirable to promote certain content or service at particular times (e.g., Christmas) or promote certain key artists (block 730). During Phase III 706, the weighting information is used to re-order a subscriber's recommendation list before proceeding to the next phase (block 732).

During the Phase IV—Filtering 708, the decision module 234 takes the list of recommendations generated in Phase II and can filter based on past purchases and device compatibility (block 733) and makes the result more specific to the specific context on the calling application (block 734). For example, it might be desirable to return only recommendations that are for a particular artist, content type, genre, or cost (block 736). It is also possible to filter out items that have already been recommended to the user or subscriber a certain number of times (block 738). According to one example, the filtering criteria are specified by the calling application as part of an API call (block 740), which is depicted as occurring prior to block 734. It is also possible to specify system wide filtering criteria such as the maximum number of times any individual should be recommended any item (block 741), depicted as following block 738, followed by updating tracking of recommendations for future counts of offerings of a recommendation to a subscriber (block 742).

According to one aspect, while Phase I 702 does not work at the individual subscriber level, Phases II 704, III 706, and IV 708 work at the individual subscriber level as Phases II 704, III 706, and IV 708 utilize an individual subscriber's data to generate targeted recommendations. That is, stored profile data 750 comprising an individual user or subscriber's profile data 752, user or subscriber attributes (e.g., age, segment, etc.) 754, and the user or subscriber's historical information (e.g., purchases, etc.) 756 are utilized as depicted in FIG. 8. Profile data 750 can also comprise user/subscriber inputs/feedback 758. In addition, decision module 234 can utilize certain subscriber specific information, depicted as preference filters 760, to automatically filter the results. According to one example, exemplary filters 760 are: (A) A subscriber's mobile device make and model 762—When such information is specified, the decision module operates to ensure that only content or service that can operate on a subscriber's device will be recommended; (B) Blocking of previous purchases 764—Decision module 234 operates to ensure that a subscriber will not be recommended an item the subscriber has already purchased; (C) Previous negative feedback 766—Decision module 234 operates to ensure that a subscriber will not be recommend an item that the subscriber has already given a negative feedback/ranking information; (D) Restricted content 768—Items can be marked as being restricted, meaning such items should not be recommended unless the subscriber has explicitly opted to receive such content (e.g., adult content, etc.). It should be noted that decision module 234 can use real time information when generating recommendations. For example, if a user or subscriber purchases or browses an item on the portal, this can immediately influence the recommendations presented to that user or subscriber. In such an example, such real time events can be fed to the profile and recommendation system 101 via the relevant API call rather than via the profile module 232 API. Alternatively, the profile API can be used only to send purchase information.

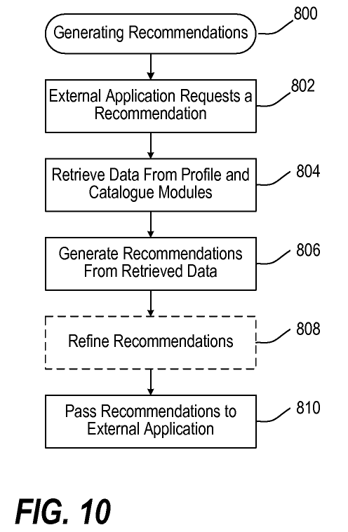

FIG. 10 shows a methodology 800 that summarizes the main operations in the process flow for generating recommendations, according to one aspect. At 802, an external (calling) application requests a recommendation for a subscriber from the profile and recommendation system, which can entail passing context or other parameters. At 804, data accumulated during the preparatory phase (described in relation to FIG. 9 previously) associated with the particular subscriber is retrieved. At 806, the decision module generates a plurality of recommendations for the subscriber based on the retrieved data. At 808, the recommendations generated at 806 are refined, to provide a final list of recommendations for the subscriber. At 810, this final list of recommendations is returned to the external application. In one instance, the external application can then pass the generated recommendations for delivery to the user or subscriber either online, via the portal, or outbound, via an SMS, MMS, WAP push message, or any appropriate mechanism to the user or subscriber's mobile device.

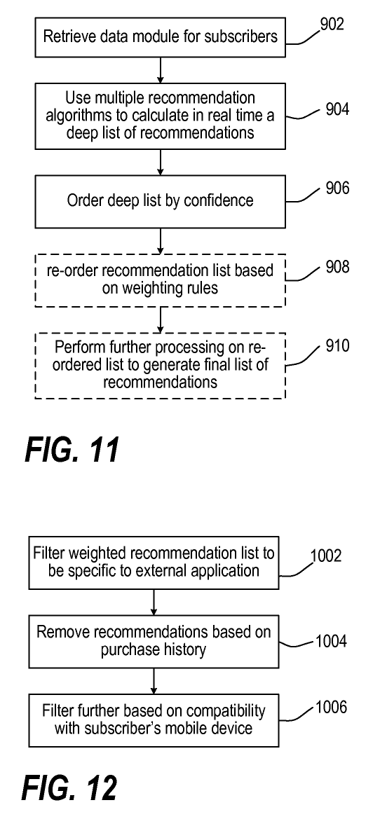

With reference to FIG. 11, according to one example, shows a process flow including further sub-operations of operations 804 to 808 of the process flow of FIG. 10. At 902, the data from a data module associated with the user or subscriber is retrieved, where the data module was built up from a periodic inspection of the stored data relating to the user or subscriber. At 904, this data is input into multiple recommendation algorithms, each of which calculates in real time recommendations for the subscriber. The resulting recommendations are combined to form a deep list of recommendations. At 906, the deep list of recommendations is ordered by a confidence level. At 908, the recommendation list is re-ordered based on weighting rules. At 910, further processing is performed on the reordered list to generate the final list of recommendations.

FIG. 12 shows a process flow of the sub-operations involved in the operation 910 of FIG. 11, according to one implementation. At 1002, the weighted recommendation list is filtered to make the list more specific to the context of the external application, which has requested the recommendations (as explained in Phase IV earlier). At 1004, those recommendations for content or service which have been previously purchased by the user or subscriber are removed from the filtered list. At 1006, those recommendations which are not compatible with the user or subscriber's mobile device are also removed. This establishes the final list of for the particular user or subscriber. It should be noted that the order of operations 1002, 1004, and 1006 of FIG. 12 can be interchanged. As depicted and described previously, filtering can further encompass restricted content and items recommended too many times already.

As mentioned earlier, according to one example, decision module 234 can use a combination of different algorithms to generate substantially the best possible recommendations. Using multiple algorithms allows decision module 234 to utilize substantially the most appropriate techniques for the quality and quantity of available data. In this manner, the decision module 234 can generate a suitable recommendation in almost any scenario.

In one example, the algorithms used to generate recommendations are controlled by a decision controller (herein also referred to as “decision recommender”). For example, in one implementation, the decision controller can be configured to use five different algorithms to generate recommendations. In doing this, the decision controller operates to call the appropriate sub routines in the specified order and then sort the recommendations generated.

According to one example, the decision controller can be configured to return recommendations within a certain time limit. For example, the decision controller may be required to generate recommendations for a particular user or subscriber within 50 milliseconds. In one instance, the decision controller can be configured to stop the recommendation generation process if generating the recommendation has taken longer than 50 milliseconds, in this example. The recommendations generated within the time allowed will be returned.

According to one example, FIG. 13 shows a block diagram of the relationship between an associate (association rules algorithm), compare (similarity algorithm), group (profiling algorithm), track (popular content algorithm), and network (social networking algorithm) recommender algorithm modules 1104, 1106, 1108, 1110, and 1112 (collectively herein referred to as “recommender modules 1114”) and a decision controller 1116, according to one aspect. As can be seen in the illustrated example shown in FIG. 13, each of the recommender modules associate, compare, group, track, and network recommender modules 1104, 1106, 1108, 1110, and 1112 takes as input the retrieved subscriber data, and processes the data to generate a list of recommendations 1118. Each list is then input to the decision controller 1116, which processes the results to output a final list of recommendations 1120.

In one example, the recommender modules 1114 can involve some pre-processing 1122 of data. The pre-processed data can then be used at recommendation generation time. This pre-processing stage can be configured to run at specific times everyday, to be run continuously, be run once offline, etc. In one instance, this pre-processing stage cleanses, processes, and structures the data into a format where it can rapidly and accurately be used during individual recommendation discovery time.

In one instance, the recommender modules 1114 can be configured to return a decision confidence level (e.g., from 1 to 5) 1124, which indicates how much confidence each of the recommender modules 1114 has in the recommended item. In one example, an item returned with a confidence level of “5 “is considered a very good recommendation, whereas a recommendation with confidence level “1” is considered a poor recommendation. According to one implementation, each of the recommender modules 1114 may be configured to further have an internal score, confidence value. For each recommendation, a recommender module 1114 can use this internal score/confidence value to generate the normalized decision confidence level. The decision controller 1116 can use the confidence level returned by each of the recommender modules 1114 to sort the respective recommendations by use of a weighting component 1126, filtering component 1128, and sorting component 1130.

According to one example, associate, compare, group, track, and network recommenders 1104, 1106, 1108, 1110, and 1112 can have the ability to provide the functionalities A, B, and C, as provided below:

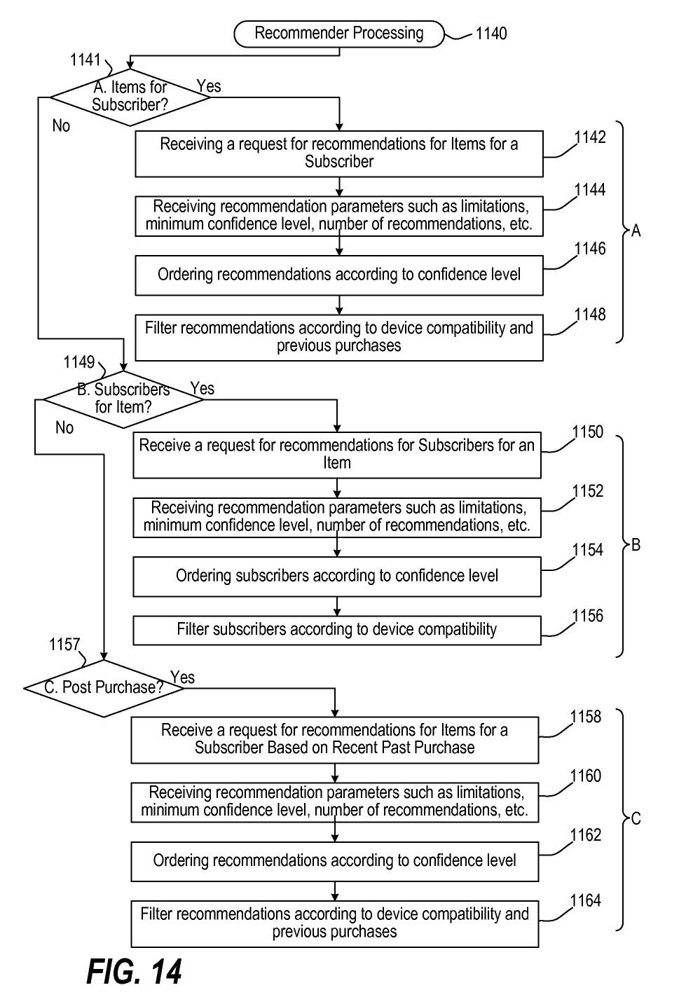

With reference to FIG. 14, a recommender processing methodology 1140 supports decision making by providing functionalities A, B and C. Functionality A pertains to finding Items for Subscriber, which is determined to be applicable in block 1141: In one example, each of the recommender modules 1114 is configured to have a function that will return a list of an individual's recommended items, depicted as receiving a request for recommendations (block 1142). The function call can take several parameters including, without limitations, minimum confidence level, number of recommendations, etc., depicted as receiving recommendation parameters (block 1144). Results can then be ordered by confidence level (block 1146). In one instance, the recommended items are configured to be compatible with the individual's mobile device (if information regarding the mobile device has been provided) and will not include an item already purchased by the individual (block 1148).

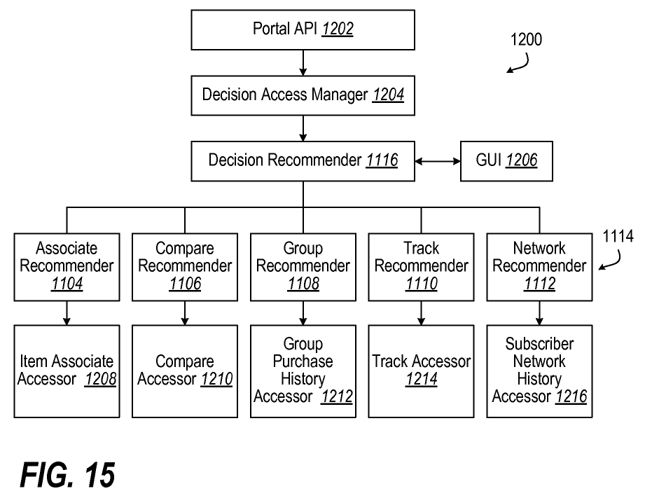

An exemplary process flow for this individual recommendation function 1200 in the decision controller 1116 as shown in FIG. 15 can include a portal API 1202 calling a Decision Access Manager (DAM) 1204 with getRecommendations call and specifying the user or subscriber, maximum number of recommendations, minimum confidence level, catalogue and profile zones, mobile device, custom attributes inclusion filter, etc. The DAM 1204 can then call the decision controller 1116 passing the user/subscriber identification, number of recommendations, minimum confidence level, catalogue and profile zones, mobile device, custom attributes inclusion filter, etc. The decision controller 1116 calls each of the recommender modules 1114 with subscriber information, number of recommendations, and minimum confidence level. Thereafter, each of the recommender modules 1114 adds its recommendations to the list of recommended items, if the recommendations are not already in the list, and are defined above the minimum confidence. The decision controller 1116 then sorts the list, and filters the list by catalogue zone, restricted content, device and custom attributes inclusion filter, etc. In one instance, only the “number of recommendations” requested are returned to DAM 1204. Subsequently, DAM 1204 can for example convert all contentItems in the list to xml and return to caller.

Returning to FIG. 14, the methodology 1140 further supports Functionality B pertaining to finding Subscribers for Item, (the best subscribers to recommend a given item to) as determined applicable in block 1149: Each of the recommender modules 1114 is configured to have a function that will return a list of the users or subscribers to whom an item should be recommended (block 1150). In one example, the call takes several parameters such as minimum confidence (block 1152), etc. Results are ordered by confidence level (block 1154). Thus, the recommended subscribers are filtered according to device compatibility (block 1156).

In one example, a process flow for this functionality as shown in FIG. 15 in the decision controller 1116 includes a graphical user interface (GUI) 1206 calling decision controller 1116 using a getSubscribersForItem call and specifying item, maximum number of subscribers, minimum confidence, catalog, and profile zones, etc. The decision controller 1116 calls each of the recommender modules 1114 with number of users or subscribers, item, minimum confidence level, catalogue zone and profile zone. Each of the recommender modules 1114 other than track recommender 1110 can add recommended subscribers to the list of recommended subscribers if the subscriber is not already in the list. After calling all the recommender modules 1114, the list is sorted and only the “number of subscribers” requested are returned to the GUI 1206.

Returning to FIG. 14, the methodology 1140 further provides Functionality C pertaining to post purchase depicted as applicable in block 1157: Each of the recommender modules 1114 can be configured to include a function that will return recommended content or service items for a subscriber based on a previous item that a subscriber has bought (block 1158). In one illustrative implementation, a post purchase recommendation is a recommendation based on an item just purchased, such as suggesting accessories or consumables usually purchased together. The call can take several parameters including an item, minimum confidence level, number of recommendations, etc. (block 1160). Results can be ordered by confidence level (block 1162). The recommended items will be compatible with the individual's mobile device (if provided) and will not have been already purchased by the individual (block 11164).

According to one example, a process flow for this function as shown in FIG. 15 in the decision controller 1116 can include the portal API 1202 call to DAM 1204 with getPostPurchaseRecommendations call and specifying already bought items, user or subscriber, maximum number of recommendations, minimum confidence level, catalogue and profile zones, mobile device, custom attributes inclusion filter, etc. The DAM 1204 calls the decision controller 1116 with bought item, subscriber, the number of recommendations, minimum confidence level, catalogue and profile zones, mobile device, custom attributes inclusion filter, etc. The decision controller 1116 calls each of the recommender modules 1114 with already bought items, subscriber, number of recommendations, and minimum confidence level, etc.

Each of the recommender modules 1114 adds its recommendations to the list of recommended items if the recommendation is not already in the list and is above the minimum confidence level. The decision controller 1116 then sorts the list and filters the list by catalogue zone, restricted content, device and custom attributes inclusion filter, and only the “number of recommendations” requested are returned to DAM 1204. Thereafter, DAM 1204 may for example convert all the content items in the list to xml and returns to the caller.

According to one example, the Portal API 1202 is the mechanism by which external systems can retrieve the results from the decision module 234. In one implementation, the portal API 1202 has three main purposes: (A) Retrieve a subscriber's recommendation(s); (B) Retrieve a subscriber's promotion(s); and (C) Retrieve information on popular content. Similarly, the profile API can perform a fourth purpose (D) Feed certain information (e.g., purchases) in real time to the profile and recommendation system 101.

Also depicted in FIG. 15, the Associate Recommender 1104 flows to an Item Associate Accessor 1208. The compare/similarity recommender 1106 flows to a Compare Accessor 1210. The group recommender 1108 flows to a group purchase history accessor 1212 and group membership accessor (not shown). The track recommender 1110 flows to a Track accessor 1214. The network recommender 1112 flows to a subscriber Network History Accessor 1216.

As shown in the illustrated example of FIG. 13, an exemplary profile and recommendation system 101 can include associate recommender 1104, compare recommender 1106, group recommender 1108, track recommender 1110, and network recommender 1112.

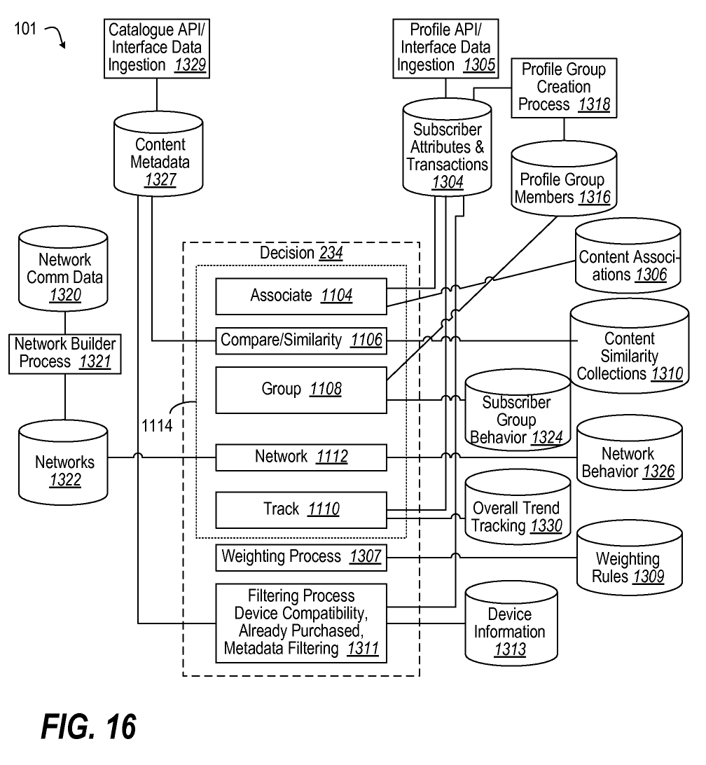

FIG. 16 shows a more detailed block diagram of the decision module 234, which includes the main parameters, associated with the process flow of the recommender modules 1114 comprising associate recommender 1104, compare/similarity recommender 1106, group recommender 1108, network recommender 1112, and track recommender 1110. A summary of each of the recommenders is provided below:

Associate (Association rules) Recommender 1104—According to one example, the associate recommender 1104 uses advanced association rule techniques to perform basket analysis on historic transaction data. Association rule data mining is a technique used for extracting patterns in purchase history data. For instance, in a supermarket shopping basket example, association rule mining will discover co-purchase relationships between all items for sale in the supermarket, by examining the combinations of items appearing in customer shopping baskets, for example —“many people who bought bread also bought milk.” An association rule can capture this relationship precisely as a mathematical probability. The supermarket owner can then study all the probabilities for all this pairs of items and stack the shelves strategically by placing items likely to be co-purchased side-by-side. The idea is using historical transaction data to influence future purchasing behavior.

For instance, for any collection of content, service, or products (e.g., downloads, ringtones, etc), if a database of transactions (e.g., the ‘shopping baskets’ in the supermarket example) is provided, it is possible to mine for association rules between the items. The association rules enable the intelligent recommendation of contents, services, or products to users, subscribers, customers in the future, based on products the users, subscribers, or customers have already purchased. Moreover, in one example, the association rules can further find more complex patterns than simple relationships between pairs of items such as “purchase of bread implies a high likelihood of purchase of milk.” More specifically, in one example, association rules can link itemsets together. An itemset is can be a group of one or more items. For instance, if A and B are any two (disjoint) itemsets, a question can be asked as to “what is the likelihood of B being present in a transaction if A is already present.” The latter sets up an association rule, which we denote by “A [symbol] B.” The Associate recommender 1104 incorporated into the decision module 234 can provide for the generation of multiple level associations, e.g., “AB [symbol] C, ABC [symbol] D,” to a maximum level of 5, “ABCD [symbol] E” (i.e. if someone buys items A, B, C, and D what is the probability that the same person will buy item E.).

In one example, the default configuration can be set to three items, i.e. if someone buys items A, B what is the probability that person will buy item C. This can be enough depth for most installations.

According to one implementation, to measure the strength of an association rule, two metrics may be defined, as provided in Table 1, below:

TABLE 1
Exemplary Association Rule Metrics

$Support ( A ⇒ B ) = P ( A U B ) = \frac{\begin{matrix}Number of transactions \\ containing A and B\end{matrix}}{Total Number of transactions }$
$Confidence ( A ⇒ B ) = P ( B \vert A ) = \frac{\begin{matrix}Number of transactions \\ containing A and B\end{matrix} }{Number of transactions containing A}$

In one example, by default, the associate recommender 1104 in the decision module 234 calculates the total number of transactions (baskets) as the number of unique subscribers who have purchased two or more items. This value is configurable.

In one example, the metrics shown in Table 1 are multiplied by 100 to express the metrics as percentages. The support measures how often the itemsets occur together in transactions in the total database, and the confidence measures how often B appears in transactions containing A. An association rule is quantified by its strength in both of these metrics.

Calculating all possible association rules between all possible itemsets can be a computationally very expensive task. In one instance, to prevent such restrictions, attention is restricted to the so-called frequent itemsets, and the associate algorithm can provide a highly optimized way to calculate the association rules. According to one implementation, associate algorithm can use the transactions from a SubscriberHistory database table of transactions to generate the item associations. In one instance, may be only the transactions with an action type “BUY” can be used to generate the associations. In such an example, only ‘BUY’ action types can be used when generating a recommendation.

In one example, the action types BUY, LIKE, DISLIKE, SUB, UNSUB, and NOT_PURCHASED, can be used. When using the latter action types in the recommendation generation, the exemplary default weights shown in Table 2 may be used:

TABLE 2
Exemplary Association Default Weights

| Transaction Type | Weighting |
|---|---|
| BUY | 100 |
| LIKE | 20 |
| DISLIKE | −20 |
| SUB | 10 |
| UNSUB | −10 |
| NOT_PURCHASED | 0 |

For instance, a “BUY” transaction may be considered more relevant than a LIKE transaction. It must be noted, however, that the default weight values can be overridden.

When generating a recommendation, the decision module 234 can look up a subscriber's past transactions 1304 that were retrieved via a profile API/interface data ingestion component 1305 and aggregate the weights per item. This information can then be used to lookup all relevant combinations of association rules. The results can then be weighted and sorted accordingly.

An exemplary flow of function calls in the associate recommender 1104 to discover items for a subscriber includes AssociateRecommender of the associate module 1104 getting items a subscriber has bought and building up itemsets of the combinations in a content association module 1306. Thereafter, the AssociateRecommender looks for associations with minimum support and confidence for each itemset, specifying the number of recommended associations each itemset should return. The AssociateRecommender builds up a query and gets item associations from an itemassociations store (e.g., DB table, etc.) checking Association Support and Confidence is above minimum. Thereafter, a number of recommendations ordered by an overall confidence level will be generated.

In one example, the AssociateRecommender can get results from an itemassociations table for each itemset. The AssociateRecommender can then check that the items have not already been bought by the subscriber by using a filtering process 1311 that can also factor in device compatibility and metadata filtering, accessing device information 1313. Thereafter, AssociateRecommender can add the items to the list and applies a confidence level using a weighting process 1307 in accordance with weighting rules 1309. The recommendations are then returned to the decision recommender 234.

In an exemplary flow of function calls in the associate recommender 1104 for obtaining subscribers to recommend an item to, the AssociateRecommender of the associate recommender 1104 takes item, minimum confidence level, catalogue and profile zones, and the number of subscribers that should be returned. Then the AssociateRecommender queries an itemassociations store (e.g., DB table, etc.) with the target Item, number of subscribers to return, and minimum confidence level seeking all the users or subscribers who have bought items in associations containing the target item, but have not bought that item, further ensuring that the users or subscribers have a mobile device that can support the item.

An exemplary flow of function calls in the associate recommender 1104 for post purchase includes the AssociateRecommender of the associate recommender 1104 using a particular item to create an itemset containing the target item. Then, AssociateRecommender then queries an itemassociations store (e.g., DB table, etc.) with minimum confidence and support for each itemset, specifying the number of recommendations to return (e.g., using a configurable property, etc.) Then, a number of recommendations ordered by an overall confidence level is returned. AssociateRecommender checks that the items are not already bought by the user or subscriber, adds the items to the list, applies weighting, verifies device compatibility, and then returns results to the decision recommender 234.

Compare Recommender 1106—In one example, the purpose of the compare recommender 1106 is to calculate the relationship between different items of content based on content metadata 1327 that receives inputs from a catalogue API 1329 that performs interface data ingestion. According to one example, the compare recommender 1106 can assist in solving the cold start problem for a new item (i.e., a new item added to the mobile operator or associated business system that has not been bought by anyone, yet). In one instance, the associate recommender 1104 may not be able to find any correlations for the new item, as no subscriber has bought this item and the item does not appear in any of the subscribers' histories.

In such a situation, the compare recommender 1106 can find items that are similar to the specific item and then for such items, find the subscribers to whom such items would be recommended. In one instance, the compare recommender 1106 compares items using metadata such as the artist, the title, the name of the containing content source, and the publisher to form content similarity collections 1310. It must be noted by one of ordinary skill in the art that any custom attributes can also be configured to be used for comparison. In one example, the latter is achieved during the content custom attribute creation process.

When comparing metadata, in one example, the compare recommender 1106 can use the weight of a piece of metadata to determine how important the piece of metadata is in comparing attributes. Weight values can be, for example, from 1 to 5, with 1 being the lowest value and 5 being the highest value. For example, a custom attribute could be called “Price Category” which can have a weighting of 1, while one of Genre can have a value of 5, indicating that the similarity of 2 items' genres is more significant than the similarity of their prices . . . .

In one example, the compare recommender 1106 can have two mechanisms by which it can compare metadata values. The first mechanism can use a straightforward case insensitive string comparison. The second mechanism can use a fuzzy string matching technique. The second mechanism is appropriate when comparing values that represent the same or a similar value, for example “FIFA 2004” and “FIFA 2005.” In one example, a mode is also provided that allows strings consisting of comma separated substrings to be compared.

In one exemplary aspect, a summary of the main operations in the process flow of the function calls in the compare algorithm 1106 to recommend items for a subscriber includes SimilarityRecommender of the compare recommender 1106 getting the items the subscriber has bought. Then, SimilarityRecommender queries an itemsimilarity store (e.g., DB table) with minimum confidence level for each bought item, specifying the number of similar items each bought item should return using a configurable property. Thereafter, the similar items ordered by similarity score are returned. In one example, SimilarityRecommender gets similar items for each user bought item and checks that the results are not already bought by the subscriber. Then, the SimilarityRecommender adds the items to the list and applies a confidence level to each. The recommendations are then returned to the decision recommender 234.

According to an exemplary aspect, a summary of the main operations in the process flow of the function calls in the compare algorithm 1106 to recommend subscribers to recommend an item to includes SimilarityRecommender of the compare recommender 1106 being passed the item, and specifying the maximum number of subscribers to return specified by a configurable property

Thereafter, SimilarityRecommender searches, for similar items, and finds subscribers who have not bought the target item but have bought one or more of the similar items. Thereafter, SimilarityRecommender adds the users to the list, sorting by confidence score, and applying a confidence level to each. Then, “number of subscribers” is returned to the decision recommender 234.

Group Recommender 1108—In one example, the group recommender 1108 is implemented to calculate the most popular items, as purchased by specified subscriber groups (i.e., a subscriber group behavior 1324). In one aspect, this recommender 1108 is particularly useful for solving the subscriber cold start problem wherein there may not be much or any historic information (purchases, likes, dislikes, etc.) for a particular subscriber. However, even in such a situation, useful subscriber meta-data or demographic information may be available, upon which recommendations can be made. For example if it is known that a particular subscriber is a male, post paid business user, this information can be used to recommend content or services that other similar demographic subscribers like.

When generating recommendations for a user or subscriber, the group recommender 1108 firstly determines the user or subscriber groups to which a user or subscriber belongs (i.e., profile group membership 1316), and then retrieves the most popular content items for those groups. Grouping can be supplied by a profile group creation process 1318 that supports subscriber attributes and transactions 1304, especially for new members without a track record, as well as supporting profile group members 1316. Such items are then filtered further (e.g., items already purchased by the user or subscriber are removed, etc.), sorted by confidence level, and returned. In another example, when recommending subscribers for an item, the group recommender 1108 may determine what subscriber groups the specific item of content is popular with, and retrieves the members of these groups 1316. The members of the groups are then filtered, sorted by confidence level, and returned.

According to one example, a summary of the main operations in the process flow of the function calls in the group recommender 1108 to recommend items for a subscriber can include the group recommender 1108 getting items subscriber has bought and getting groups to which the subscriber is a member 1316. Then, GroupRecommender 1108 retrieves from storage (e.g., DB table, etc.) optionally using profile zone and specifying the number of items that should be returned (using a configurable property), the most purchased items for each group. Thereafter, the number of items ordered by purchase frequency is returned. GroupRecommender checks they are not already bought by the user, adds the items to the list, and applies a confidence score. The recommendations are then sorted and returned to the decision recommender 234.

In one exemplary aspect, a summary of the main operations in the process flow of the function calls in the group recommender 1108 for subscribers to recommend an item to includes GroupRecommender 1108 consulting a data store (e.g., DB table, etc.) for the item to get all the groups in which the item has been purchased a configurable number of times. For each group, the group recommender gets the users or subscribers who have not bought this item and have a device that supports this item. GroupRecommender 1108 can further add these subscribers to the list of subscribers if above the minimum confidence level and checks if restricted content is allowable for each subscriber or not.

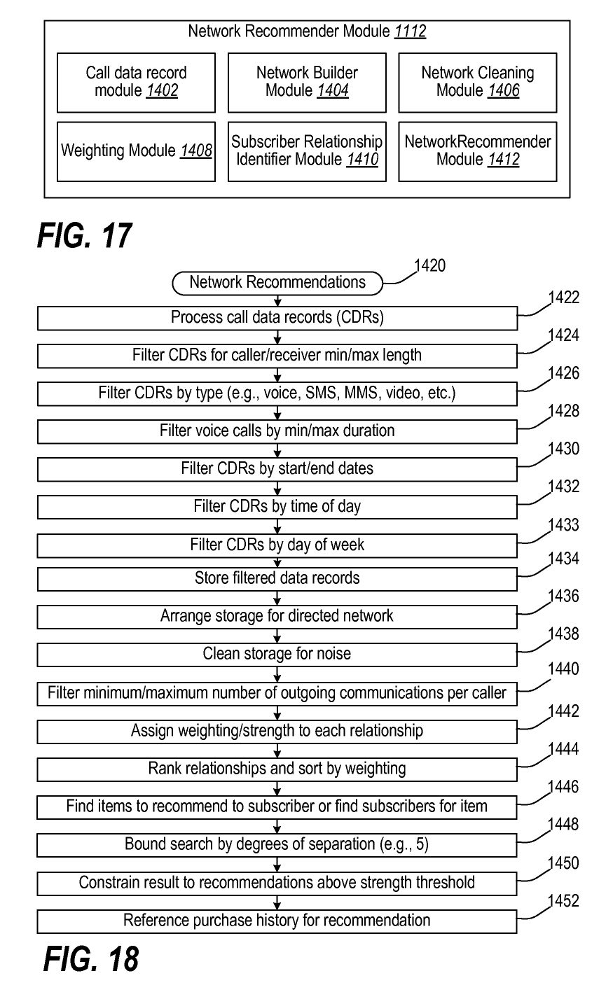

FIG. 17 shows a block diagram of the main components of the Network Recommender 1112, according to one aspect. It includes a call data record module 1402, a network builder module 1404, a network cleaning module 1406, a weighting module 1408, a subscriber relationship identifier module 1410, and a NetworkRecommender module 1412. These modules will be described in more detail below. In one example, the network recommender 1112 uses peer-to-peer (P2P) communication data 1320 (e.g., call, SMS data, etc.) ingested by a network builder process 1321 to create P2P (peer-to-peer) networks 1322. These networks 1322 can then be used to generate recommendations for a user based on the behavior of members of their local network 1322. In one example, the network recommender 1112 uses call data records (CDRs) based on mobile device usage (talking, SMS, MMS, 3G, etc.) to build a network of links between pairs of users who communicate using the respective mobile devices. This social network 1322 can then be used to recommend items to people (or vice versa) by polling an individual's network links in order to study the purchase behavior of those individuals in his/her local network.

With continued reference to FIG. 17, according to one aspect, the network recommender 1112 consists of at least three modules, specifically the network builder 1404, the network cleaner 1406, and the NetworkRecommender algorithms 1412.

With reference to FIG. 18, a methodology 1420 for network recommending is depicted, according to one aspect. In one example, the network builder 1404 takes as input a list of CDRs from the call data record module 1402, where a CDR is simply a line of data capturing a communication between two mobile devices (block 1422). An exemplary CDR can be “CALLER_NUMBER, RECEIVER_NUMBER, CALL_TYPE, CALL_TIME, CALL_DURATION, CALL_COST.” The utility can be configured to set up one or more “filters” on the incoming CDRs. In one aspect, a filter is a list of rules, which the CDRs must pass. In one example, a filter verifies the following: (A) The caller and receiver numbers have the specified prefixes and minimum/maximum length (block 1424); (B) the call has a specified type (voice, SMS, MMS, video, etc) (block 1426); (C) Voice calls are within the specified minimum/maximum duration (block 1428); (D) The CDR falls between a specified start/end date in the calendar (block 1430); and (E) The time of the CDR falls between the specified daily hours (block 1432). The day of the week of the CDR is also filtered (block 1433).

Each set of such filters can define a separate network. For instance, one such network might capture CDRs which represent communications from 8 am-6 pm, Monday to Friday—i.e., a business network. Another network capturing CDRs from Friday 6 pm to Monday 2 am would be a social network.

In one example, any data records, which pass through the filters, are sent to a “Network Summary” table where, in one instance, P2P links are stored as a single row and agglomerated (block 1434). That is, if a CDR from caller A to receiver B comes in, the table is checked for an existing row for A to B. If a row already exists, the row is updated with the information in the new CDR. Otherwise, the CDR is inserted as a new row. In this way, each line of the final Network Summary table represents the total communication activity between two people.

According to one example, each of these networks is configured to be directed (block 1436), meaning the link “A---→B” is considered to be different from the link “B---→A.” As such, if CDRs exist for a communication from A to B, and from B to A, each will be in a different row in the Network Summary table. In one example, the filters can be set up and configured in an XML file, which may be called for example “RawRecordFilters.xml.”

In one instance, the Network Summary table will contain a certain amount of noise, e.g., automated services like train timetables, weather, news alerts, taxi drivers, etc. Such data is not useful from the point of view of recommendations, and so the network recommender 1112 is designed to remove such data from the Network Summary table using the cleaning module 1406 (block 1438). According to one aspect, for each network created in the NetworkBuilder module 1404, a separate filter can be created which operates to clean only that network. A filter can specify for example the max/minimum number of outgoing communications any caller can be allowed to have (block 1440). Thus, callers violating these thresholds are removed from Network Summary.

In one example, once the Network Summary table has been cleaned, the network recommender 1112 is configured to assign a weighting (or strength) to each relationship (i.e. row in the table) by means of the weighting module 1408 (block 1442). This is so that an individual's links can be ranked in order to identify his/her “best” friends (i.e. ones with strongest weightings) (block 1444). In one example, these filters may be setup and configured in an XML file, such as for example “NetworkSummaryTableCleaner.xml.”

Once the Network Summary table is built and cleaned, the network recommender 1112 can be used to find items to recommend to a subscriber or find subscribers to whom an item can be pushed (block 1446). In one example, for a given subscriber, the subscriber's “neighbors” (people directly linked to him/her), then their neighbors, etc. are identified (herein referred to as “degrees of separation” or just degrees) by the subscriber relationship identifier module 1410 (block 1448). Thus, a person two degrees away from an individual refers to an individual linked to somebody the individual is linked to (i.e. a friend of a friend). In one instance, the most popular items among these people form the recommendations for the subscriber.

The network recommender 1112 can be configured to examine people up to 5 degrees away from a subscriber. The network recommender 1112 can further be configured only include people within the degrees of separation whose pair wise weighting is above a certain strength (block 1450). In this case, the higher the weighting threshold is, the closer the relationships become.

According to one example, the network recommender 1112 can be used to recommend items to a subscriber that has a purchase history. In such a scenario, the subscriber's purchase history can be used to generate recommendations for the subscriber and exclude already purchased items (block 1452).

In one exemplary aspect, a summary of the main operations in the process flow of the function calls in the network recommender 1112 includes the decision controller 1116 getting the items the subscriber has bought and passes them to NetworkRecommender 1412 of the network recommender 1112. In one example, using a threshold passed in, the NetworkRecommender 1412 works out how many degrees to search in a subscriber's local network.

In one example, the NetworkRecommender 1412 searches the subscriber's local network for items purchased by members of that local network within the specified degrees of separation and following only P2P links with weight above a specified threshold, and only polling those members having made a specified and configurable minimum number of purchases. The NetworkRecommender 1412 then checks that each item is not already bought by the target subscriber, adds the items to the list, and applies a confidence level to each. The recommendations are then returned to the decision controller 1116.

In another exemplary aspect, a summary of the main operations in the process flow of the function calls in the network recommender 1112 to discover subscribers to recommend an item, includes using the given item, and finding people who have already bought it. Then, the neighbors of each of these people become our targets for the item. Notably, it can be specified that only neighbors having the weight above a certain threshold and within a number of degrees of separation can be considered. Within each local network, the people who have not bought the given item can be identified, and of those, only the people whose number of purchases exceeds a minimum configurable level, are added as targets for recommendation.

Returning to FIG. 16, Track Recommender 1110 is described. In one example, the track recommender 1110 can be used to monitor and record the most commonly used content or services i.e., provide overall trend tracking 1330. This information is then used to return a recommendation based on the most popular items. In one example, the track recommender 1110 can be used to target popular items to a subscriber. In one example, the results from the track recommender 1110 may be used when another algorithm is unable to provide a more targeted recommendation (e.g., a subscriber cold start situation). The track recommender 1110 can further be used to look up most popular content in the catalogue during a specified time period. An example of this type of recommendation would be displaying a “what's hot” list to portal users. In one example, the track recommender 1110 uses a TrackContentItem table, which is built from transaction data in a SubscriberHistory table. In one instance, before generating the TrackContentItem table, a period of time in which to look at historical transactions can be specified.

In one exemplary aspect, a summary of the main operations in the process flow of the function calls in the track recommender 1110 to recommend items for a subscriber includes the TrackRecommender getting the most popular items supported by the subscriber's device and not previously purchased by the subscriber. Then, the TrackRecommender uses profile zone, and specifies the number of items that should be returned using a configurable property TrackRecommender builds up a query and gets the items from TrackContentItem table returning the specified number of items ordered by each item's count. TrackRecommender thereafter get checks RestrictedContent, content not already bought by the subscriber or user, adds the items to the list, and applies a confidence level. The recommendations are then returned to the decision controller 1116.

In a further exemplary aspect, the profile and recommendation system 101 of the present disclosure can use a best seller recommender.

However, according to one aspect, the best seller recommender is separate from the recommenders 1114, and can be referred to as more of a standalone module. In one example, the latter is reflected at the code level defining the best seller recommender outside the decision recommender class architecture. While, in one aspect, the recommenders 1114 are aimed at finding items for a subscriber, or items for another item, the best seller recommender can be considered additionally as a statistics tool.

The best seller recommender, in one simple example, operates to allow the user to look up the most popular content from a subscriber history table of transactions, searching by user actions (BUY/LIKE/DISLIKE/VIEWED, etc.) and time period (a configurable collection of past times, e.g., last hour, last 12 hours, last day, last week, etc.). In an optional aspect, passing a subscriber into the best seller recommender may have two additional effects on the items being returned: (A) Items already purchased by the subscriber are hidden; or (B) If appropriate, restricted items are hidden from the subscriber.

In one example, when the subscriber is passed in, functionally, the best seller recommender can operate very similar to the track recommender 1110. In one example, the best seller recommender can look at actions other than purchases. Additionally, similar to the track recommender 1110, the best seller recommender data can be stored in the TrackContentItem table, alongside track recommender data, and share the same format. In one example, setting up the best seller data generation can consist of adding a single property comprising a comma separated list of allowable time periods. For example, the property “1 H,7 H,1 D,7 D,999 D” indicates five different time periods (1 hour, 7 hours, 1 day, 7 days, 999 days) in which the best seller recommender will be able to search backwards in time. The preparation phase will slice the subscriber history table of transaction data into the time periods specified in the above property and store this information in the TrackContentItem table alongside the track recommender data. If the time period specified by track is one of those specified by the best seller recommender, the data generation for that period can happen only once.

In one example, the best seller recommender can be available only as an API call GetTopContentByTimeAndAction. In one aspect, Simple Object Access Protocol (SOAP) parameters such as an action (BUY/VIEWED/LIKE etc), or comma separated list of actions, and a time period (e.g., 12 H or 7 D etc) may be mandatory.

It will be appreciated that the parameters given to a decision call provide the mechanism for recommendation generation. They combine the business rules with the input and output to/from the decision recommenders to generate the final recommendation that will be given to the subscriber. The parameters further qualify the output from the decision recommenders.

In one example, specifying parameters is achieved via the provided API call parameters. In addition, system wide global parameter defaults can also be specified. According to one aspect, decision module API parameters can be used to provide the following capabilities: (A) Recommender selection; (B) Rules used to select exactly what recommender(s) configurations decision will use to perform its recommendations; (C) Input criteria; (D) The subscriber and content filtering criteria are passed as parameters to the Decision module. These are then used when examining the available profile and catalogue data; (E) Result interrogation; and (F) The output from decision module is examined to determine if a good recommendation has been found. Decision module 234 will return a degree of certainty value for each recommendation the decision module 234 makes as a confidence level. The rule can specify an acceptable minimum degree of certainty, which if not attained, can result in another, or a different recommender being tried.

For example, according to one aspect, a decision call is made, requesting the return of recommendation to a subscriber from the available content in the catalogue module. Decision module might return with a recommendation but with a low degree of certainty. In this situation, the recommendation may be disregarded, and default to a specific (fixed) item of content that the administrator 213 is anxious to promote.

Another example is where an item of content is required for cross-selling. Decision module 234 can recommend content or service that may not be the most obvious or common choice. The latter can be used to avoid making recommendations, which have little value to the subscriber (e.g., recommending a particular artist's last hit when a subscriber has just bought their most recent release).

According to one example, subscriber filtering can be used to allow an administrator 213 to specify the subscribers a particular type of recommendation can be made. This is used when creating a recommendation for a particular subscriber (e.g., an online recommendation shown on the portal, etc.). For example, a decision rule may be created that restricts the presentation of recommendations to subscribers with a particular type of device or attribute (e.g., post-paid, high spender, etc.).

In another example, subscriber filtering can be used to pre-select a subset of subscribers for whom recommendations are to be generated. This is used when creating an outbound promotion based on this rule. For instance, the administrator 213 can specify the subscriber filtering criteria via the user interface of the recommendation application 212, that allows them to select attributes from a list and perform simple or logic (e.g., MMS Device and post-paid, pre-paid or youth, etc.).

With regard to content filtering, content filtering can refine the types of content that will be recommended. For example, an administrator 213 can create a rule that will only recommend an item of MMS content. Therefore, in one example, the APIs associated with retrieving recommendations also have the ability to specify certain criteria regarding the type of recommendation that should be returned (e.g., genre of a music track, etc.). While this allows the calling application great control, it may mean that changes to the user experience may require re-coding of the application making the API call. To avoid the latter, the profile and recommendation system 101 can provide recommendation profiles. Recommendation profiles can be created via the user interface of the recommendation application block 212 (depicted in FIG. 4), and allow an administrator 213 to specify values for all the parameters of a recommendation API call. The calling application then references this recommendation profile, instead of specifying values for the individual parameters. Decision module 234 will then populate the parameter values from the profile. The recommendation profiles thus allow the administrator 213 to change the user experience without necessitating code redevelopment.

According to one example, the response time in which the decision module 234 can service may be important. Response time criteria can be measured in 10 s or 100 s of milliseconds, servicing several hundred requests per second. In one example, the factors that can influence performance can be the number of recommenders used and the volume of data in question.

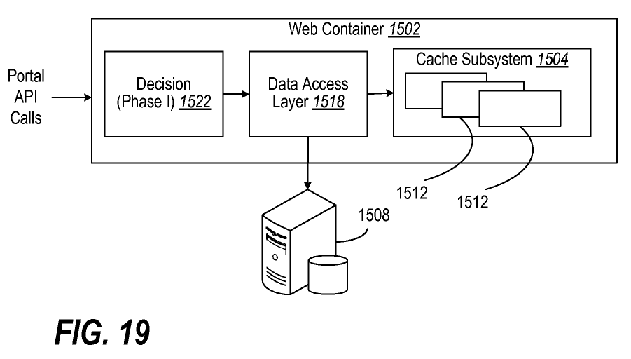

According to one aspect, FIG. 19 is a diagram that illustrates how decision module 234 meets these performance requirements with a web container 1502. In one example, a number of different techniques, such as caching in a cache subsystem 1504 and database access to a database 1508 can be used to meet the performance requirements. Decision module 234 can use intelligent caching of frequently accessed data to enhance performance, according to one aspect. The volume and lifetime of cached data elements can be controlled to suit the available quantity of data and hardware resources available. According to another aspect, if caching is not in place, decision module 234 can use fine tuned SQL and JDBC, for example, to retrieve data. All SQL and database schema objects are designed to provide maximum performance and scalability.

The caching mechanism within decision module 234 can utilize a number of different caches 1512 for storage of the different types of frequently accessed data. The most commonly used caches are those that hold information on subscriber history, item data including custom attributes, and data generated by the different algorithms during phase I (e.g., item association data, similarity comparisons, networks, etc.).

A data access layer 1518 is used to abstract data loading from other components of decision module 234. When a request for an item of data is made, the data access layer 1518 first checks the caching subsystem to see if the data is already loaded. If the data has already been loaded, the data is returned. If the data has not been loaded, the data access layer 1518 loads the data from the database and inserts the data into the cache before returning it. The caching subsystem 1504 manages purging of old or unused data. In one example, the caching subsystem 1504 uses both an item of data's last access time and overall cache size to determine what should be purged.

In one example, a consideration within decision module 234 is the amount of time required to perform phase I data preparation outlined previously with respect to FIG. 9. While this process does not have the same impact on user experience, one should note that unreasonable hardware resources are not required, and that the process can be completed within a reasonable period of time. In one instance, where possible, the phase 1 analysis depicted at 1522, is done in an incremental fashion (i.e., processing new data and combining the new data with existing results).

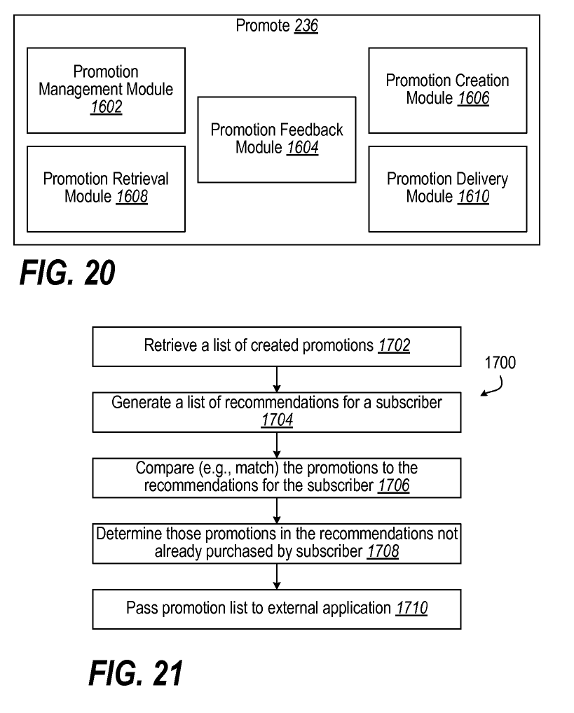

Referring to FIG. 20, according to one example, the main components of the promote module 236 are depicted. As described with respect to FIG. 4, in one example, the promote module 236 offers the ability to create engaging outbound promotions and support the creation of dynamic content pages on the web portal, so as to increase customer uptake and commitment. The promote module 236 comprises a promotion management module 1602, a promotion feedback module 1604, a promotion creation module 1606, a promotion retrieval module 1608 and a promotion delivery module 1610. The functionality of each of these modules will be explained in greater detail below.

With reference to FIGS. 4 and 20, in one example, in a promotion, an administrator 213 creates a number of campaigns around specific items. For instance, the promotion may be created around certain items that a business is trying to introduce to people. This can be done by an administrator 213 via the recommendation application 212 (FIG. 4) in communication with the promotion creation module 1606 and promotion management modules 1602, automatically, or as explained below.

In one example, the profile and recommendation system 101 can determine the most relevant promotions for an individual subscriber and the most appropriate time to deliver them. By making the promotions interactive, the mobile operator can maximize the chance of the subscribers making a purchase. For example, if the mobile operator wants to build a Star Wars section of the mobile operator's portal, the profile and recommendation system 101 can group all such content and services (e.g., ringtones, screensavers, desktops, trailers, film reviews, games, ticket services, etc.) onto a single page or section of the portal with no manual intervention. It must be noted that in such an example, only content and services applicable to the subscriber or the user and their mobile device capabilities are displayed.

Furthermore, according to one example, the online behavior of users or subscribers is profiled, building a view of their buying habits as well as the success of promotions and offers made to them. All of this information can then be used to define the best method and the best time of day/week to promote a new offer. In this manner, a promotion is delivered to the user or subscriber when it has the highest chance of statistical success and through a channel to which the subscriber is most likely to respond. For example, if a subscriber sends five (5) or more peer-to-peer messages between 5:30 and 6:30 PM on weekdays, this pattern can be identified, and can be used as a promotional window for that subscriber. In all probability, the subscriber may be commuting home from work on a train or bus and may be using the time to catch up with friends and organize the evening's entertainment, a perfect time to promote to them.

The promote module 236 can further make it possible to create targeted promotions via multiple channels, by providing an intelligent and automated means of driving the usage of content services via both online and outbound mechanisms. The promotions are delivered via the promotion delivery module 1610. In one example, an online mechanism is a promotion utilized for subscribers that visit a mobile operator's wired or wireless portal. An outbound promotion is a promotion that is sent to users or subscribers via a mechanism such as SMS, MMS, WAP push, etc.

In one example, online promotions are facilitated by the communication between the promotion retrieval module 1608 and the services and content information component 208, which in one example, comprises the portal 226. In one example, this integration is performed via a Portal Applications programming interface, a SOAP based API that allows the portal to retrieve information from the promotion retrieval module 1608 (e.g., the best promotions for a particular subscriber, etc.) and return usage information (e.g., subscriber has expressed interest in a promotion, etc.) via the promotion feedback module 1604. In cooperation with the portal, promote module 236 can track which subscribers have visited the portal, which promotions have been viewed, and which have resulted in a click-through. An example use is when the portal requests details of the best advertisement for a specific subscriber via the promotion retrieval module 1608. Promote module 236 will return details of the advert (including text, image, links, etc.). The portal will then present this advert in the appropriate position on the site.

In addition to the portal API providing information to the portal, the portal also can feed back information to promote module 236 by means of the profile feedback module 1604. This enables promote module 236 to learn more about subscribers' behaviors and thus work more effectively. Examples of this include reporting that a subscriber has visited the portal, and promotions that have resulted in a purchase as well as the promotions that did not result in a purchase. Because promote module 236 is aware of this information, promote module 236 can provide reports on campaign effectiveness.

According to one aspect, different types of online promotions can be performed by promote module 236, each of which provides different ways to present targeted promotions to subscribers as they navigate the portal. The following are exemplary online promotions:

Banner Adverts: These are targeted advertisements that are placed on the portal where they can be viewed and selected by the user or subscriber. When selected by the subscriber, the subscriber is shown the details of the promotion, which the subscriber can then proceed to purchase, if desired. In one example, banner adverts are graphical adverts. Banner adverts can also be defined with a display scope that allows promotions to be shown in relevant parts of the portal (e.g., showing a ringtone promotion in the ringtone section as opposed to the financial news section, etc.).

Post-purchase Adverts: These are advertisements that are shown to subscribers following a purchase. The content being cross-sold can either be configured by the profile and recommendation system administrator 213 or can automatically be generated by the decision module 234.

Bundles: Individual pieces of content or services can be grouped together and offered to subscribers for purchase at a discounted rate. Bundled information is sorted in promote module 236 where the portal can retrieve it. When the subscriber purchases a bundle, the portal controls fulfillment in conjunction with the profile and recommendation system. In one example, promote module 236 records bundle purchases for future use.

Targeted Menu Links: These are links that are placed within the portal menu structure, targeted to bring subscribers to areas of the portal where the subscribers can be offered relevant content or services. The placement of these links in relation to other static or personalized links is controlled by the portal management system.

Outbound promotions are based around outbound broadcasts and a number of Inbound Communication Mechanisms, as follows:

Broadcasts: Promotional broadcasts to groups of subscribers can be created by means of the promotion management module 1602. The broadcast message can be an SMS, MMS, or WAP push message, and can be useful in promoting new content and services.

SMS Based Campaigns: For SMS, in one example, promote module 236 automatically manages the subscriber content/session information. An administrator 213 can specify through communication with the promotion management module 1602 the message text that subscribers should give to progress through the conversation (regular expressions are supported to provide more powerful matching). Default catch-all statements can be added to capture incorrect messages and return a context sensitive help message.

WAP Based Campaigns: When using the WAP channel, the administrator 213 can specify the individual pages that will be displayed on a mobile device. These pages can include text, images, data entry fields (entered data is stored in variables), links to external WAP pages, etc.

In one example, broadcasts can be delivered by means of the promotion delivery module 1610 as WAP push messages, that when activated by subscribers will bring them to an online version of the promotion. This is provided for in the following three ways: (A) The link contained in the WAP push message points to another system (e.g., a portal, etc.) where information about the promotion is available. This can be an ideal mechanism for making subscribers aware of a new service on a portal; (B) Details of the subscribers that respond are recorded, and they are then redirected to another system (e.g., a portal, etc.). This can be useful when real-time tracking of subscriber responses is required. Promote module 236 then provides real-time, online reports that show the total number of respondents; and (C) The link points to a page containing details of the promotion. In one example, the administrator 213 can create the promotional page via the What You See IS What You Get (WYSIWYG) editor communicating with the promotion creation module 1606. The promote module 236 can render the promotional information, including images, to a mobile device Hyper Text Mark-Up Language (HTML), Wireless Mark-Up Language (WML), Extensible Hyper Text Mark-Up Language (XHTML)). The subscriber can view the promotional information directly from promote module 236; images and links to external portals can be included. This solution may be utilized when a single WAP deck can be used to communicate the promotion (e.g., like a flyer, etc.) and provide an onward link to more detailed information or purchase dialog. This option allows for the rapid creation of promotions without the need to update the mobile operator's portal.

In one example, a part of outbound promotions is to provide an inbound communication mechanism for subscribers to follow up on a promotion. Promote module 236 provides the following mechanisms:

Interest Groups: Subscribers can register their interest in a particular promotion or topic by responding (e.g., via SMS, etc.) with a simple keyword. Promote module 236 can automatically track which items subscribers have expressed interest in, and store this information for future use. This can provide an ideal approach to building up subscriber-based marketing mechanisms such as loyalty groups or communities.

Interactive Campaign: Promote module 236 operates to support the creation of more complex campaigns and interactive services by means of the promotion creation module 1606 through the use of its Conversation Scripting Application (CSA). The CSA provides a graphical way of creating these conversation scripts by allowing administrators to drag and drop components or called statements on the CSA screen, and linking these together to create the various conversation paths that subscribers can follow when taking part in a campaign.

In one example, integrated simulators can be provided that allow campaigns to be easily tested and demonstrated. In addition to providing a powerful campaign service creation environment, the conversation engine can provide very high performance that is scalable to many hundreds of subscriber interactions per second.

In one example, the execution of outbound promotions can be carried out via the subscriber profile information source 210, when comprising, for example, an external CRM or marketing automation system, such as Epiphany of Infor Global Solutions GmbH, Alpharetta, Ga., Unica Corporation of Waltham, Mass., or Chordiant Software, Inc. of Cupertino, Calif. This integration can be as simple as creation of broadcasts, or can extend to creation of fully featured interactive campaigns with results being fed back into the CRM or marketing system. In one example, this integration is provided via promote's group and broadcast management API.

The promote module 236 also enables targeted promotions to be achieved, by the creation of profile groups. These lists may be either imported by the profile and recommendation system or generated by it using the accumulated subscriber usage information.

Promote module 236 can be deployed on its own or in conjunction with other modules of the profile and recommender system, including the profile module 232, the catalogue module 230, and the decision module 234. If deployed alone, promote module 236 provides administrators with the ability to quickly create and execute targeted promotions to specified subscribers by means of the promotion creation module 1606. If used in conjunction with profile module 232, catalogue module 230, and decision module 234, promote module 236 has the ability to provide more targeted, automated, and sophisticated promotions that will achieve a higher success rate. This is possible because when used in combination with the other profile and recommendation modules, promote module 236 can leverage the power of decision to provide better promotion selection for online subscribers. With decision module 234, rules and algorithms are used that leverage the information in the profile module 232 and catalogue module 230 to arrive at the best possible promotion to target subscribers. Suggested outbound promotions are also automatically calculated and presented to the user. Decision module 234 can take the created promotions and determine which subscribers should be targeted in an outbound manner. Automatic promotion creation may also be provided from the information stored in catalogue module 230. In one example, without the other profile and recommendation system components, it is necessary for an administrator 213 to manually identify the content/services that they wish to promote. However, when decision module 234 is used, the decision module 234 can automatically generate recommendations (e.g., post-purchase, outbound broadcasts, etc.) directly from the information stored in catalogue and profile modules 232 and 234, respectively.

A promotion can often include a discounted price for the content or service in question. Promote module 236 allows administrators to pre-rate the content, by providing this discounted tariff information for use during execution of the promotion. Depending on how billing integration is achieved, this promotional tariff information can either be passed to the billing system directly from promote module 236, or to the portal, and to billing, there from. Promote module 236 also provides web-based management features to administrators, which, by interfacing with the promotion management module 1602, can provide the ability to effectively manage many simultaneous broadcasts, and can easily scale to deliver many millions of messages per day. These features may include: (A) A customizable authorization process, based on specific broadcast details such as volume, throttling, time, etc.; (B) Broadcast restriction periods (e.g., 9:00 a.m. to 5:00 p.m. Monday to Friday), with administrator override if required; (C) Throttling of generated message to network guidelines; (D) Daily and weekly view of running or future broadcasts; (E) Limit on number of messages that can be sent per day—this may be a requirement put in place by the network; (F) Real-time reporting and control over long-running broadcasts. Reports show the percentage of broadcasts completed and an estimated finish time. Administrators have the ability to easily pause, resume, and stop a broadcast; and (G) Recurring broadcasts, daily, weekly, and monthly.

It should be noted that because of the high degree of automation provided by promote module 236, it is possible to run many smaller (more targeted) promotions as opposed to a smaller number of large generic promotions. Furthermore, promote module 236 enables broadcast definitions to be tailored to a particular subscriber. For example, it is possible to control the number of broadcasts that a subscriber should receive within a certain period, the time of day subscribers should receive broadcasts, and the subscribers' preferred contact mechanism (e.g., SMS, MMS, etc.).

In one example, promote module 236 can also generate and deliver unique coupons as part of a broadcast or a follow up channel. These can be used to redeem certain benefits such as discounts, credits, gifts, or merchandise, etc.

According to one aspect, variables may also be used in the text of a broadcast, in order to tailor its contents to subscribers. These variables are subscriber specific values that can be set up by an administrator 213, external systems, or the subscriber themselves. For example, it is possible to include a subscriber's name or balance in a broadcast. Variables can also be used to implement loyalty points wherein the subscriber builds up points as they respond to campaigns. Variable values may be accessible to external system via an XML API.

In one example, promote module 236 can also provide real-time reports on success (or failure) of promotions. It can provide statistics on the number of subscribers that have viewed, expressed interest in, responded to, or rejected a particular promotion. The ability to see these results in real-time means that events that are run regularly can be modified immediately to ensure their future effectiveness, successful events can be rerun, and those that are not successful can be dropped.

According to one aspect, promotions can be accessed via the portal API in a manner similar to recommendations. The portal API provides several APIs for the purpose of requesting a promotion and feeding back promotion related user events (e.g., click through) into the profile and recommendation system. In another example, promotions can be accessed via communication between the user interface of the recommendation application block 212 and the promotion management module 1602 for the purpose of generating an outbound promotion via SMS, MMS, WAP push, etc. In this case, the promote delivery module 1610 can be used to actually deliver the outbound promotion or simply generate a list of the target subscriber phone numbers. When generating the target list of subscribers, it is possible to specify both the number of subscribers and the required minimum confidence level. This means it is possible to do such things as generate the top 100,000 subscribers that should be targeted by a particular item, with a certain minimum degree of confidence.

In accordance with one implementation, promotion creation by means of the promotion creation module 1606 can involve three stages, First Stage (General Details), Second Stage (Target Subscribers), and Third Stage (Delivery).

In the First Stage, the administrator 213 specifies some general details about the promotion, including: (A) Name and description; (B) Type of promotion (e.g., Banner Ad, WAP Link, Bundle, Cross-sell, etc.); (C) Weight—The weight of a promotion is used when selecting the best promotion for a subscriber where more than one candidate promotion exists. For example, if two promotions exist that specify the same profile groups, the weight will be used to determine the correct promotion for a subscriber in this group; (D) Item on offer—This can be a specific piece of content from catalogue module 230 (e.g., Pac Man Java Game, etc.), or a category of content selected from catalogue module 230 (e.g., Polyphonic Rock Ringtones, etc.); (E) A link to an item of content hosted on an external system (e.g., Business Headlines); (F) Scope—The scope of a promotion identifies an area where this promotion is appropriate, for example, a promotion may be created with a scope of ringtone specifying that it should be shown on the ringtone part of the portal.

During the Second Stage, the administrator 213 is asked to specify the mechanism of identifying the target subscribers for this promotion. The target group specifies the subscribers to whom the promotions can be presented. There are three illustrative options:

Option A. Global—Promotions that are targeted globally can possibly be shown to any subscriber, so long as the subscribers have not already seen the promotion a certain number of times or purchased the promotional item. Global promotions can have a lower weighting than other more targeted ones;

Option B. Profile Group(s)—The administrator 213 can also specify one or more profile groups to which a promotion will be available. These groups can be lists of subscriber phone numbers imported into profile module 232, or can be created by profile module 232 from recorded subscriber activity or attributes; and

Option C. Decision. When decision module 234 is utilized to determine if a particular promotion should be shown to a subscriber, decision module 234 first determines an extensive list of the recommendations for that individual and then compares this list to the items contained within that promotion. If any item within the promotion is on that user's recommendation list and the subscriber has not already purchased any item in the promotion, then that promotion is eligible to be shown to the subscriber. If this targeting mechanism is selected, it is then possible to select the minimum confidence level that decision should have for this promotion to be eligible for display to a subscriber.

At the third Stage, the administrator 213 specifies the collateral that will be used to present the promotion to a subscriber. This can be divided into online and outbound collateral. In online collateral, the administrator 213 is prompted to provide the Web and WAP based text or graphics that will be displayed on the portal. In one example, both summary and detailed collateral are specified. Summary information is shown first to subscribers, and the detailed information is shown once the subscriber requests more information on the promotion. This type of collateral is made available to the portal via the Portal API. In outbound collateral, the administrator 213 is configured to supply collateral for the different outbound mechanism they wish to use. The administrator 213 could specify SMS, MMS, WAP Push, etc. content. This information will then be used by the promotion delivery module 1610 when executing the outbound promotion.

FIG. 21 shows a flow diagram of an exemplary process flow 1700 in the promote module 236. At 1702, a list of promotions created by an administrator are retrieved which have been. At 1704, recommendations are generated for a subscriber. At 1706, the promotions are compared to the recommendations for the subscriber, such as by checking for a match. At 1708, the promotions which are in the recommendation list but have not already been purchased by the subscriber are determined (in one example, the previous processing may make this check superfluous). At 1710, this list of promotions is passed to an external application. The external application can then pass these promotions for delivery to the subscriber either online, via the web portal, or outbound, via an SMS, MMS, WAP push, etc. message to their mobile device.

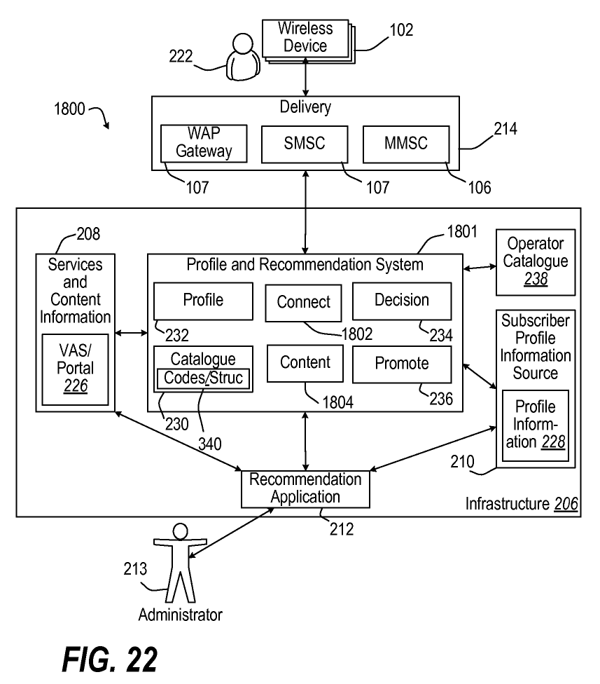

In addition to the above-mentioned modules of the profile and recommendation system, according to one example, in a profile and recommendation network 1800, a profile and recommendation module 1801 can include additional modules. FIG. 22 details the above-mentioned components of FIG. 4 of the profile and recommendation system, along with content module 1804 and connect module 1802, according to one aspect.

The content module 1804 provides content management and delivery capability for a range of content or services. Connect module 1802 enables the delivery of SMS, MMS, WAP, and downloadable content. According to one example, all industry standard network connectivity and delivery protocols are supported. The content module 1804 can operate to integrate with a subscriber profile information source 210, such as billing, for charging for the content or services. In addition, content module 1804 can integrate with pre- and post-paid systems via a variety of protocols. Content module 1804 can also integrate with the services and content information block 208 to show available content or services on the web or WAP portals (e.g., title, artist, previews, etc.) and to trigger delivery of content or services.

In one example, content module 1804 offers the ability to locally store, manage, and deliver any content type. Content and information can be securely stored and managed via a web interface, for example, and delivered via carrier-grade download, alert, and on-demand content servers.

The profile and recommendation system can further support a variety of mechanisms for the automatic acceptance and collection of content from external sources. The platform can be configured to accept content feeds in the form of HTTP/XML or File Transfer Protocol (FTP)/XML from external sources, and provide a framework for implementing content provider specific mechanisms for content integration. According to one aspect, the profile and recommendation system can also proactively retrieve content from external sources such as RSS. In one example, the profile and recommendation system content submission API can be used by content providers to manage their content using a defined XML format over HTTP.

Content module 1804 can further be configured to provide active or inactive update, depending on the type of content validation that may be required. The administrator 213 can provision the type of authorization required for each type of content. In one example, trusted content can be automatically validated, whereas other types of content may require approval from the administrator 213 or the mobile operator's content manager.

Furthermore, content module 1804 can support the creation and management of subscription based alerts as well as delivering SMS, MMS, or other content types. Subscribers can create a schedule of personalized alerts specific to their interests with the ability to define parameters such as bearer (e.g., SMS v MMS, etc.), time of day delivery, language, time zone, etc. The alert module of the content module 1804 has the ability to scale to the requirements of the mobile operators, providing timely delivery of content or services.

According to one example, the content download module provides download server for all downloadable types of content including, without limitations, Java, ringtones, wallpapers, etc. In one example, the content download module provides the following features: (A) Delivery of Java applications (e.g., games, etc.), Java Archive (JAR) or Java Application Development (JAD) format (2 stage download); (B) Each download can be assigned a unique URL and can have its own token ID; (C) JAD file is rewritten to specify dynamic location of JAR download; (D) Download retries can be allowed for a configurable period of time or number of attempts; (E) Digital rights management (DRM) can be applied to downloaded content; (F) Download can be initiated via WAP push or directly from the WAP portal; and (G) The CSR interface for user activity lookup is based on Mobile Subscriber Integrated Services Digital Network Number (MSISDN), with the capability to resend download if required.

The module can be configured to use substantially all possible standards and techniques to ensure successful download and accurate billing of downloaded content. This can include a download notification API that allows the download server to notify an external system as the different stages of the download happen. These notifications can be used to stop the download at any point, or generate billing events.

According to one example, the connect module 1802 can be configured to have Digital Rights Management (DRM) capability, which provides the ability to apply Open Mobile Alliance (OMA) DRM v1 Forward Lock, Combined Delivery and Separate Delivery to selective content as defined by the platform administrator or content providers.

In one aspect, connect module 1802 includes a transcoding engine that can be configured to support transcoding between a wide variety of content formats and codecs. In addition, the transcoding engine can be configured to provide its own device profile database that is tested and tuned specifically for the purpose of delivering multimedia content.

According to one aspect, the connect module 1802 can handle three content delivery scenarios, as follows:

Scenario 1. Information on Demand: In this scenario, the services or content requests are handled by mapping the services or content requests to the relevant content source, retrieving the current content or service from that source, and returning it to the subscriber;

Scenario 2. Scheduled Delivery: Scheduled delivery can be based either on a fixed delivery schedule specified by the system administrator 213 or on a subscriber defined schedule. In this situation content or services are retrieved and delivered to subscribers at the times specified in their schedules; and

Scenario 3. Unscheduled Delivery: Delivery of unscheduled content or services can be triggered either manually or automatically via an external event. In this situation, content or service is pushed to subscribers from the content or service source.

Content module 1804 can be integrated with an existing portal via the provided Portal API, or in situations where an existing storefront is being replaced, content module 1804 can provide a storefront that can be customized to a mobile operator's requirements. Content module further provides an “out-of-the-box” storefront, which enables mobile operators to merchandise content or services across multiple storefronts and multiple delivery channels. This default storefront can be customized to meet the functionality and branding requirements of a specific mobile operator.

In one example, because the storefront has been pre-integrated with the rest of the profile and recommendation system, the storefront can make best use of the overall system features. According to one aspect, the storefront can allow the mobile operator to: (A) Offer a comprehensive range of services to subscribers; (B) Promote new services; (C) Create offers around content bundles; (D) Provide a ‘user-friendly’ interface for subscribers to purchase and subscribe to content services; (E) Display market segment-specific versions of the storefront; and F) Create top-ten lists to promote new/popular services.

Additionally, the storefront can allow the subscriber to: (A) View the complete range of content services on offer (either all services or services available in their market segment); (B) Purchase content services (e.g., games, ringtones, etc.); (C) Subscribe to content services (e.g., alerts, etc.); (D) Manage their subscriptions to content services; and (E) Specify their own schedule for delivery of content.

In the situation where content or service is to be sold over different channels, the profile and recommendation system can be configured with multiple storefronts. For example, a mobile operator may market its content or services through multiple brands or resellers. In one example, a customized storefront can be supported for each channel.

Content module 1804 can further be configured to provide a secure, reliable, and audited mechanism of storing and managing content. In one instance, security is provided via SSL and username/password authentication. According to one example, access to content can be segregated, thus restricting content providers to accessing their own content. Content review and authorization can be performed either by platform administrator 213 or by external content owners.

In one aspect, intelligent content selection can be used to ensure that the type of content offered by providers can be delivered in an optimal format that matches the capabilities of a user or subscriber's device. By mapping device capabilities to devices and content or service items, determination can be made by the profile and recommendation system as to which service or piece of content to deliver. Where a device has a number of device capabilities, the profile and recommendation system can use a system of weighting to determine the most appropriate content to deliver.

With continued reference to FIG. 22, in one example, data for catalogue and profile modules 230 and 232, correspondingly, can be imported from systems (e.g., billing, CRM, Valued Added Services (VAS) platforms (e.g., alerts platform, etc.), etc.) via connect module 1802. In one aspect, connect module 1802 provides a way of simplifying and automating the import and export of information for the profile module 232 and the catalogue module 230 into and out of the profile and recommendation system.

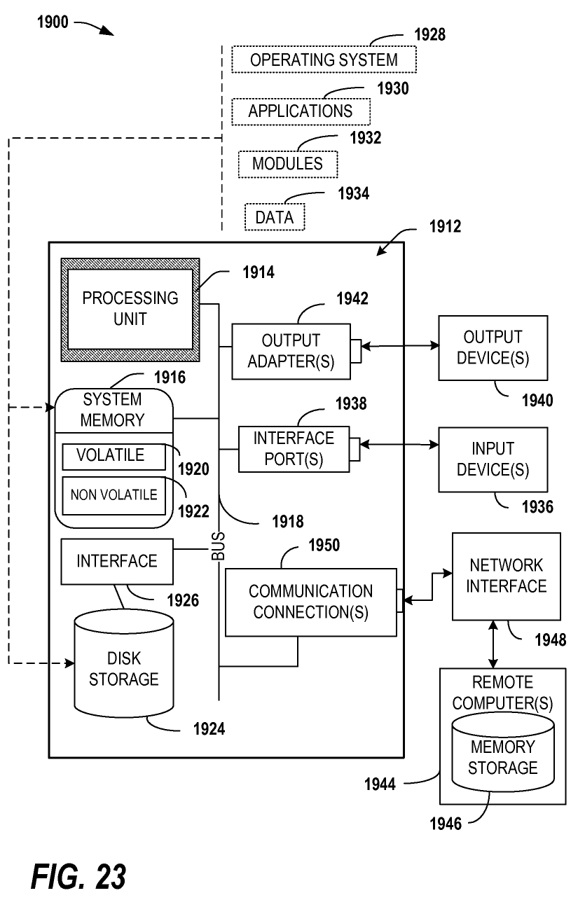

With reference to FIG. 23, an exemplary environment 1900 for implementing various aspects of the claimed subject matter includes a computer 1912. The computer 1912 includes a processing unit 1914, a system memory 1916, and a system bus 1918. The system bus 1918 couples system components including, but not limited to, the system memory 1916 to the processing unit 1914. The processing unit 1914 can be any of various available processors. Dual microprocessors and other multiprocessor architectures also can be employed as the processing unit 1914.

The system bus 1918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1916 includes volatile memory 1920 and nonvolatile memory 1922. The basic input/output system (BIOS), containing the basic routines to transfer information between elements within the computer 1912, such as during start-up, is stored in nonvolatile memory 1922. By way of illustration, and not limitation, nonvolatile memory 1922 can include read only memory (ROM), programmable ROM (PROM), electrically programmable ROM (EPROM), electrically erasable programmable ROM (EEPROM), or flash memory. Volatile memory 1920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1912 also includes removable/non-removable, volatile/non-volatile computer storage media. FIG. 23 illustrates, for example, disk storage 1924. Disk storage 1924 includes, but is not limited to, devices like a magnetic disk drive, floppy disk drive, tape drive, Jaz drive, Zip drive, LS-100 drive, flash memory card, or memory stick. In addition, disk storage 1924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1924 to the system bus 1918, a removable or non-removable interface is typically used such as interface 1926.

It is to be appreciated that FIG. 23 describes software that acts as an intermediary between users and the basic computer resources described in the suitable operating environment 1900. Such software includes an operating system 1928. Operating system 1928, which can be stored on disk storage 1924, acts to control and allocate resources of the computer system 1912. System applications 1930 take advantage of the management of resources by operating system 1928 through program modules 1932 and program data 1934 stored either in system memory 1916 or on disk storage 1924. It is to be appreciated that the claimed subject matter can be implemented with various operating systems or combinations of operating systems.

A user enters commands or information into the computer 1912 through input device(s) 1936. Input devices 1936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1914 through the system bus 1918 via interface port(s) 1938. Interface port(s) 1938 include, for example, a serial port, a parallel port, a game port, and a universal serial bus (USB). Output device(s) 1940 use some of the same type of ports as input device(s) 1936. Thus, for example, a USB port may be used to provide input to computer 1912 and to output information from computer 1912 to an output device 1940. Output adapter 1942 is provided to illustrate that there are some output devices 1940 like monitors, speakers, and printers, among other output devices 1940, which require special adapters. The output adapters 1942 include, by way of illustration and not limitation, video and sound cards that provide a means of connection between the output device 1940 and the system bus 1918. It should be noted that other devices and/or systems of devices provide both input and output capabilities such as remote computer(s) 1944.

Computer 1912 can operate in a networked environment using logical connections to one or more remote computers, such as remote computer(s) 1944. The remote computer(s) 1944 can be a personal computer, a server, a router, a network PC, a workstation, a microprocessor based appliance, a peer device or other common network node and the like, and typically includes many or all of the elements described relative to computer 1912. For purposes of brevity, only a memory storage device 1946 is illustrated with remote computer(s) 1944. Remote computer(s) 1944 is logically connected to computer 1912 through a network interface 1948 and then physically connected via communication connection 1950. Network interface 1948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1950 refers to the hardware/software employed to connect the network interface 1948 to the bus 1918. While communication connection 1950 is shown for illustrative clarity inside computer 1912, it can also be external to computer 1912. The hardware/software necessary for connection to the network interface 1948 includes, for exemplary purposes only, internal and external technologies such as, modems including regular telephone grade modems, cable modems and DSL modems, ISDN adapters, and Ethernet cards.

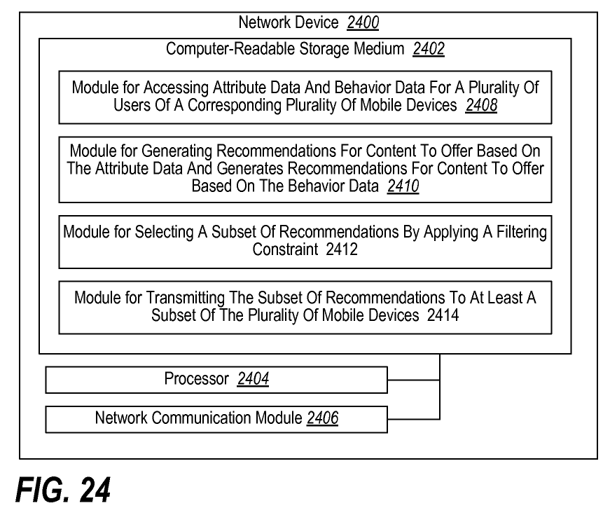

In FIG. 24, a network device 2400 contains a computer-readable storage medium 2402 containing means for causing one or more processors 2404 to perform methodologies described herein for profiling and recommending content to users of wireless devices. Such means can be sets of software code, firmware, hardware module implementations, or a combination thereof. A network communication module 2406 facilitates transmitting recommendations to wireless devices, which in the illustrative implementation is by communicating with a mobile operator (not shown in FIG. 24). In an illustrative aspect, a module 2408 accesses attribute data and behavior data for a plurality of users of a corresponding plurality of mobile devices. A module 2410 generates recommendations for content to offer based on the attribute data and generates recommendations for content to offer based on the behavior data. A module 2412 selects a subset of recommendations by applying a filtering constraint. A module 2414 transmits the subset of recommendations to at least a subset of the plurality of mobile devices.

In one instance, profile and catalogue modules 232 and 230, correspondingly, can provide HTTP/XML-based APIs for the transfer of data. These APIs (in conjunction with the web based UI) can meet the data exchange requirements of deployments (e.g., deployments in the early stages, etc.). In one instance, data exchanges requiring more complex integration can also be supported. In one example, connect modules 1802 handles data exchanges via the use of data exchange agents capable of providing mechanisms for importing and exporting content in different formats using a variety of different transport mechanisms. Connect module 1802 can also support external systems having their own means of representing data. For instance, such external system may have specific requirements/capabilities as to how the external systems can distribute or accept data. Additionally, external systems may use different transportation mechanisms for online or offline (batch) transportation. For instance, hypertext transfer protocol (HTTP), Simple Object Access Protocol (SOAP), COntent-Based Retrieval Architecture (COBRA), Remote Method Indication (RMI), etc. can be used for online mechanisms; whereas FTP and Message Queues can be used for offline mechanisms. The transport layers of connect module 1802 support multiple configurable transports.

In one example, the transportation layer is responsible for: (A) Retrieving of data via the appropriate protocol. This may involve retrieving a file via FTP and opening it, or accepting XML encoded data via HTTP; (B) Streaming the data to the configured encoders. It is possible to pass data simultaneously to multiple encoder instances to improve performance; (C) Archiving data. Optionally storing processed data for future reference; and (D) Each Transporter is associated with an Encoder, with which it can create one or more instances to process received data. Multiple Transporters can be configured for each integration point.

In one example, connect module 1802 can use encoders to translate data from that of an external system to a format acceptable by profile module 232 or catalogue module 230, and vice versa. Encoders are aware of an implementation specific data format and know how to translate from this format into that required by the profile and recommendation system. In one example, the encoders main responsibilities can be: (A) Accept input from the transport agent; (B) Validate the received data, and generate exception reports where necessary. Exception reports contain records of badly formatted or incomplete data; (C) In one aspect, it may be difficult to receive data that does not contain unnecessary or unwanted data. In the latter scenario, encoder filters are used to determine the data elements that should be discarded; (D) Insert, update or deletion of data from profile or catalogue modules 232 and 230, respectively; and (E) Provide detailed logging of encoding activity. In one example, executing, encoders have full access to the data already contained within profile and catalogue modules 232 and 230, correspondingly. This allows the encoders to check on existing data before importing a new item.

According to one aspect, the profile and recommendation system provides certain default encoders for common data formats. New encoders can easily be developed that implement a new or customer specific data format. In one example, encoders may be written in Java. This also allows customers or integrators to write new encoders using a robust, high performance and industry standard language with which they are familiar.

In one example, the portal API of the profile and recommendation system is a SOAP-based system that gives content provider websites, web portals, or other end-user systems access to the profile and catalogue information of the profile and recommendation system. In one example, the portal API can be used for the following: (A) Provide targeted promotions (e.g., banner ads, etc.) as defined by promote module 236; (B) Populate content available via the portal from the information held in the catalogue module 230 (e.g., wallpapers, ringtones, etc.); (C) Provide search functionality from the metadata held in the catalogue module 230); (D) Provide customized information from the information held in the profile module 232; and (E) Update the profile and recommendation system with the events that occur on the portal (e.g., subscriber visit, clicking on an advertisement, purchasing an item of content, etc.).

It will be appreciated that some deployments of the present disclosure will utilize the disclosure primarily for its central catalogue combined with promotional and portal integration capability. In this scenario, emphasis can be placed on maintaining catalogue module 230 with complete and up-to-date information regarding content and services. The promote and decision modules 236 and 234, correspondingly, can be utilized as much as possible to increase uptake. In this scenario, it is possible to extend the portal integration from the normal promotional aspects (banner ads, etc.) to where the portal takes some or all of what it knows about the available content or services from catalogue module 230. Another deployment may be focused on utilizing the present disclosure for its promotional and delivery capability. The solution chosen will depend on the customers' requirements and can evolve over time.

In one or more aspects, the profile and recommendation system of the present disclosure can be deployed on a common underlying architecture, which delivers carrier-grade performance, reliability, and scalability. The architecture can also provide a consistent point of integration to network delivery infrastructure, CRM, billing and other BSS systems. In addition, the common architecture can support multiple solutions built from various capabilities in a highly modular and configurable fashion.

According to one example, the profile and recommendation system may be deployed on different hardware, including, without limitations, those running Solaris, HP-UX, Linux, and Windows. In one aspect, the profile and recommendation system can be split into three layers, each of which can be deployed on shared or different hardware depending on the mobile operator's deployment standards and performance requirements. In one example, an Oracle database may be used for data storage and managing data storage.

According to one example, the architecture of the profile and recommendation system can operate to provide the highest level of performance required by high volume mobile operators. Decision module 234 provides high volume, real-time recommendation generation from an extensive database of profile and catalogue information. Promote module 236 can deliver high volume online and outbound promotions, and content module 1804 can manage and deliver large volumes of content.

In one example, the profile and recommendation system can further provide a redundant deployment thus ensuring substantially no single point of failure. In this manner, high availability of all revenue-generating services can be ensured. The profile and recommendation system 101 can also provide carrier-grade reliability and availability through the use of: (A) Hot standby configuration where the function of each software component can be moved to a backup server; (B) Utilization of servers with built-in redundant hardware components; (C) Load balancers at all interface points; (D) Oracle 9i Database Technology, providing high throughput and high availability database access; and (E) Simple Network Management Protocol (SNMP) monitoring and alerts, and Simple Mail Transfer Protocol (SMTP) alerts, allowing integration with existing network management platforms.

The profile and recommendation system can further provides powerful scalability options that meet a customer's current and forecasted performance requirements with cost-effective and flexible utilization of processing resources. In one or more example, all components of the architecture can be multi-threaded and designed to make maximum usage of multiple CPU servers. Depending on the resources available, according to one aspect, the system can be configured appropriately, giving full control over such processing elements as threads and database connections. In addition to providing scalability within a host, the profile and recommendation system can be scaled across several nodes, with the addition of new nodes providing for an almost linear increase of system performance.

Additionally, according to one or more aspects, the profile and recommendation system can provide a variety of APIs that enable the system to be easily integrated with other applications. In one nonlimiting example, such APIs include XML/SOAP, RMI, JDBC, etc. Many integration points can also be provided that allow new or existing business logic to be inserted into the processing flows of the different modules.

Furthermore, according to one example, the profile and recommendation system can provide intuitive web-based administration and provisioning of all aspects of platform operation and system workflow. The system can further provide for base platform administration as well as interfaces for the administration of each of the modules.

Additionally, the profile and recommendation system can provide SNMP integration with management systems such as HP Openview. The system can also provide detailed log files for all system components; the logging level being configurable per component. In one or more aspects, the logging level can be changed in real-time.

Still further, the profile and recommendation system can support a variety of network connectivity protocols (e.g., Short Message Peer-to-Peer Protocol (SMPP), Computer Interface to Message Distribution (CIMD), Universal Computer Protocol (UCP), EAIF, MM7, MM1, Password Authentical Protocol (PAP), and over-the-air (OTA). In one example, the platform can simultaneously connect to an unlimited number of network delivery points and perform complex content routing.

It should be noted that the profile and recommendation system can be configured to support the delivery of content or service to users or subscribers of more than one mobile Operator or a mobile operator with several subsidiaries.

Additionally, the profile and recommendation system can provide network management by means of bandwidth control using content provider peak message output and security management by supporting access control on all external interfaces through the use of SSL, VPN, source-address validation, and user/password validation as appropriate to the protocol in question.

The profile and recommendation system can further be used to throttle the rate at which messages enter the system from applications and messaging centers. In addition, it can be used to ensure that certain application traffic is given priority.

Moreover, according to one or more aspects, the profile and recommendation system can provide a reporting function, which is responsible for capturing the relevant system data for report generation or customer service queries. The system can capture substantially all details of traffic required to produce a full audit trail. A variety of reports can be available through the administration website. In one aspect, the types of reports available may depend on the solution deployed. In one example, by default, the different components may come with a variety of the most commonly used built in reports. However, the profile and recommendation system provides for additional, customer specific reports to be created. In one example, an embedded reporting tool may be used. With this approach, it is possible to create the desired custom report with an advanced GUI tool and have the report easily available from the profile and recommendation website. From the website, it is possible to view summary information (in textual or graphical form) and to download detailed information in CSV format. In one example, reporting may include a management dashboard, which includes a Web based interface statistics from all service usage and promotions and an alert capability for preset triggers.

Reporting may also include a Real-Time Dashboard, which can provide information such as the current health status of all servers, the current status of all active servers, trend information on number of transactions per service, trend information of transaction volume by content provider, top 10 current recommendations by subscriber type, response per recommendation, etc.

According to one or more aspects, the profile and recommendation system of the present disclosure can help mobile operators with a complex mix of services and a diverse subscriber base, to proactively promote the uptake of content or services by providing a unified view, advanced profiling, and intelligent recommendations. Its capabilities can enable mobile operators to overcome current restrictions in actively retailing all of their content or services across the mobile channel (e.g., how to cross-promote content services from multiple disparate systems, how to sell to individual subscribers based on their demographics, funds available and usage patterns, how to improve the user experience by matching services applicable to the device and subscriber without missing the opportunity to sell, how to automate tightly targeted promotions, etc.).

The profile and recommendation system of the present disclosure can overcome all of the above mentioned issues by providing an end-to-end retailing environment for mobile operators that, for example: (A) Maximizes the selling opportunities available to the mobile operator; (B) Automates promotion of content and services with minimal staff overheads; (C) Maximizes the existing investment in the Mobile Operators current content and data platforms; Enhance all relationships the mobile operator has with content providers; (D) Improves retention and create subscriber commitment; (E) Increases Data ARPU by actively drive higher margins (e.g., at least 3 times); and (F) and Reduces complexity.

Variations, modification, and other implementations of what is described herein will occur to those of ordinary skill in the art without departing from the spirit and scope of the disclosure as claimed. Accordingly, the disclosure is to be defined not by the preceding illustrative description but instead by the spirit and scope of the following claims.

What is claimed is:

1. A method for generating recommendations for a user of a mobile device, the mobile device associated with a service provider, the method comprising:
obtaining a request for a recommendation;
retrieving data associated with a user and data on content available for a mobile device from a service provider;
generating a plurality of recommendations based on an analysis of the retrieved data, wherein the recommendations are generated by a plurality of different recommendation techniques; and
selecting a subset of the generated plurality of recommendations based upon filtering constraints.

2. The method of claim 1, further comprising delivering the generated recommendations to a user interface accessible by the user.

3. The method of claim 2, wherein the delivering the selected subset of recommendations further comprises delivering the selected subset of recommendations to a portal associated with the service provider.

4. The method of claim 3, further comprising:
detecting user interaction with a selected portion of the portal;
defining the filtering constraints as associated to an aspect of the selected portion with the plurality of recommendations; and
selectively displaying the subset of recommendations in response to user access of different portions of the portal.

5. The method of claim 2, wherein the delivering the generated recommendations to the user interface accessible by the user further comprises delivering the recommendations to a mobile device.

6. The method of claim 5, wherein the delivering to the mobile device is via a wireless application protocol (WAP) push message to a portal associated with the service provider.

7. The method of claim 5, wherein the delivering to the mobile device is via a short message service (SMS) message.

8. The method of claim 5, wherein the delivering to the mobile device is via a multimedia messaging service (MMS) message displayed on the mobile device.

9. The method of claim 1, wherein the generating the plurality of recommendations further comprises:
providing retrieved data to each of the different recommendation techniques to generate recommendations, each recommendation generated having an associated confidence level; and
combining the recommendations from each of the recommendation techniques in order of confidence level.

10. The method of claim 9 further comprising:
reordering the recommendations based on user defined weightings; and
filtering the reordered recommendations.

11. The method of claim 10, further comprising:
receiving the request for recommendation containing a specific constraint; and
filtering the reordered recommendations by filtering in accordance with the specific constraint.

12. The method of claim 10, wherein the filtering the reordered recommendations further comprises removing a recommendation previously availed of by the user or already presented to the user a certain number of times.

13. The method of claim 10, wherein the filtering the reordered recommendations further comprises removing a recommendation not compatible with a mobile device.

14. The method of claim 9, further comprising normalizing the confidence levels obtained from the different recommendation techniques.

15. The method of claim 1, wherein the plurality of recommendation techniques is selected from the group consisting of an associate recommender, a compare recommender, a group recommender, a track recommender, or a network recommender.

16. The method of claim 15, wherein the network recommender further comprises:
selecting a plurality of persons from a list of users within a local network of a target user, the plurality of persons being within a specified number of degrees of separation;
determining popular content previously availed of by the selected plurality of persons; and
generating recommendations based on the determined service provider and popular content.

17. The method of claim 16, wherein selecting the plurality of persons further comprises identifying the users from the local network of the target user who are associated with high weighting values.

18. The method of claim 17, wherein the weighting values are assigned by:
retrieving person-to-person mobile communication data for the user from the service provider;
filtering the person-to-person communication data to remove unwanted communication data; and
assigning a weighting value to each of the filtered person to person aggregate communications, wherein the assigned value is proportional to quantity and type of person-to-person communication activity.

19. The method of claim 18, wherein the filtering the person-to-person communication data further comprises:
removing communication data from unwanted sources.

20. The method of claim 19, wherein the unwanted sources are identified by the respective unique phone numbers.

21. The method of claim 18, wherein the filtering the person-to-person communication further comprises removing communication data that are unwanted due to type or duration of communication.

22. The method of claim 18, wherein the filtering further comprises removing communications data that are unwanted due to time or day of communication.

23. The method of claim 18, wherein the person-to-person mobile communication data further comprises one or more of voice calls, short message service (SMS) messages, multimedia messaging service (MMS) messages, or mobile communication method.

24. The method of claim 15, wherein the associate recommender further comprises:
building association rules from a user's behavior data retrieved from a service provider; and
generating recommendations based on the built association rules.

25. The method of claim 15, wherein the compare recommender further comprises:
building links between similar content data available to the user utilizing content meta-data; and
generating recommendations based on the built links.

26. The method of claim 15, wherein the track recommender comprises:
determining a history of users activities so as to build a ranking of all content data, content data being ranked by popularity; and
generating recommendations based on the ranking.

27. The method of claim 26, wherein the activity of users comprises content purchases, ratings, or other user expressions of interest over a configurable time period.

28. The method of claim 1, wherein the data associated with the user comprises a selection of one or more of call data, date of birth, gender, prior purchases, expressions of interest, expressions of disinterest, spending pattern, mobile device type, current geographical location, call frequency, or other user metadata

29. The method of claim 28, further comprising maintaining the associated user data up to date when generating a recommendation.

30. The method of claim 1, wherein the request for a recommendation is obtained from a portal associated with a service provider.

31. The method of claim 1, wherein the recommendations are generated in real time so as not to detract from the user experience.

32. The method of claim 1, wherein recommendations are generated in a period of time less than 200 milliseconds.

33. A method for generating promotions for a user of a mobile device, the user associated with a service provider, the method comprising:
retrieving a list of promotions from a service provider;
retrieving data associated with a user and data on the content available to the user from the service provider;
generating a list of recommendations for the user by analysis of the retrieved data, wherein the recommendations are generated by a plurality of individual recommendation techniques;
selecting for delivery a subset of the retrieved promotions, the subset of retrieved promotions including promotions that are in common with the recommendations in the recommendation list and have not been already availed of by the user.

34. A computer program product, comprising:
a computer-readable storage medium comprising,
at least one instruction for causing a computer to obtain a request for a recommendation;
at least one instruction for causing the computer to retrieve data associated with a user and data on the content available to the user from the service provider; and
at least one instruction for causing the computer to generate a list of recommendations based on an analysis of the retrieved data, wherein the recommendations are generated by a plurality of different recommendation techniques.

35. A system for generating recommendations for a user of a mobile device, the user associated with a service provider, the system comprising:
means for obtaining a request for a recommendation;
means for retrieving data associated with a user and data on the content available to the user from the service provider; and
means for generating a list of recommendations based on an analysis of the retrieved data, wherein the recommendations are generated by a plurality of different recommendation techniques.

36. A system for generating recommendations for a user of a mobile device, the user associated with a service provider, the system comprising:
a profile module for storing and processing data associated with the user;
a catalogue module for storing and processing content available to the user; and
a decision module in communication with the profile module and the catalogue module, the decision module used for generating a list of recommendations for the user by analysis of data retrieved from the profile and catalogue modules, wherein the recommendations are generated by a plurality of individual recommender modules.

37. The system of claim 36, wherein the decision module includes an associate recommender, a compare recommender, a group recommender, a track recommender, and a network recommender.

38. The system of claim 37, wherein the network recommender comprises:
a call data record module, a network builder module, a network cleaning module, a weighting module, a relationship identifier module, and a network recommender module.

39. The system of claim 36, wherein the profile module comprises: a profile database module, a profile management module, a profile grouping module, and a profile ingestion module.

40. The system of claim 36, wherein the catalogue module comprises: a content grouping module, a searching module, a content management module, a content database module, and a content ingestion module.

41. A system for generating recommendations for a user of a mobile device, the user associated with a service provider, the system comprising:
a profile module for storing and processing data associated with the user;
a catalogue module for storing and processing content available to the user;
a decision module in communication with the profile module and the catalogue module, the decision module used for generating a list of recommendations for the user by analysis of data retrieved from the profile and catalogue modules, wherein the recommendations are generated by a plurality of individual recommender modules; and
a promote module for comparing the recommendations with a database of promotions of the service provider and for generating a list of promotions based on the comparison.

42. The system of claim 41 wherein the promote module further comprises: a promotion management module, a promotion feedback module, a promotion creation module, a promotion retrieval module, and a promotion delivery module.

43. A method for generating recommendations for a user of a mobile device, comprising:
accessing attribute data and behavior data for a plurality of users of a corresponding plurality of mobile devices;
generating recommendations for content to offer based on the attribute data and generating recommendations for content to offer based on the behavior data;
selecting a subset of recommendations by applying a filtering constraint; and
transmitting the subset of recommendations to at least a subset of the plurality of mobile devices.

44. The method of claim 43, further comprising receiving a request for recommended users for a selected content item.

45. The method of claim 43, further comprising applying a filtering constraint by accessing an exclusion constraint.

46. The method of claim 45, further comprising accessing the exclusion constraint by,
tracking a number of offerings of a selected content item to a selected user; and
excluding further offerings of the selected content item to the selected user in response to reaching a threshold.

47. The method of claim 45, further comprising accessing an exclusion constraint by receiving a category restriction for a selected user.

48. The method of claim 45, further comprising accessing an exclusion constraint by determining that a selected content item has previously been selected and received by a selected mobile device of a selected user.

49. The method of claim 48, further comprising identifying a content item for recommendation that is associated with the previously selected content item.

50. The method of claim 45, further comprising accessing an exclusion constraint by determining device compatibility of a selected wireless device for a selected content item.

51. The method of claim 43, further comprising selecting a subset of recommendations by applying a filtering constraint by determining a confidence level of a plurality of recommendations of selected content items and applying a weighting factor in accordance to the confidence level.

52. The method of claim 51, further comprising sorting the plurality of recommendations in accordance to the confidence level.

53. The method of claim 43, further comprising the immediate updating of behavior data for a selected user of a wireless device based upon user interaction with presented offerings of recommendations.

54. The method of claim 43, further comprising associating a selected user of a wireless device with a group of users and selecting recommendations based upon the group association.

55. The method of claim 54, further comprising accessing attribute data and behavior data consisting of call data, date of birth, gender, prior purchases, expressions of interest, expressions of disinterest, spending pattern, mobile device type, current geographical location, call frequency, or other user metadata

56. At least one processor for generating recommendations for a user of a mobile device, comprising:
a first module for accessing attribute data and behavior data for a plurality of users of a corresponding plurality of mobile devices;
a second module for generating recommendations for content to offer based on the attribute data and generating recommendations for content to offer based on the behavior data;
a third module for selecting a subset of recommendations by applying a filtering constraint; and
a fourth module for transmitting the subset of recommendations to at least a subset of the plurality of mobile devices.

57. A computer program product for generating recommendations for a user of a mobile device, comprising:
a computer-readable storage medium comprising,
at least one instruction for causing a computer to access attribute data and behavior data for a plurality of users of a corresponding plurality of mobile devices;
at least one instruction for causing the computer to generate recommendations for content to offer based on the attribute data and to generate recommendations for content to offer based on the behavior data;
at least one instruction for causing the computer to select a subset of recommendations by applying a filtering constraint; and
at least one instruction for causing the computer to transmit the subset of recommendations to at least a subset of the plurality of mobile devices.

58. An apparatus for generating recommendations for a user of a mobile device, comprising:
means for accessing attribute data and behavior data for a plurality of users of a corresponding plurality of mobile devices;
means for generating recommendations for content to offer based on the attribute data and generating recommendations for content to offer based on the behavior data;
means for selecting a subset of recommendations by applying a filtering constraint; and
means for transmitting the subset of recommendations to at least a subset of the plurality of mobile devices.

59. An apparatus for generating recommendations for a user of a mobile device, comprising:
a profile storage component containing attribute data and behavior data for a plurality of users of a corresponding plurality of mobile devices;
a profile and recommendation system for generating recommendations for content to offer based on accessed attribute data, for generating recommendations for content to offer based on accessed behavior data, and for selecting a subset of recommendations by applying a filtering constraint; and
a network communication module for transmitting the subset of recommendations to at least a subset of the plurality of mobile devices.

60. The apparatus of claim 59, further comprising the network communication module for receiving a request for recommended users for a selected content item.

61. The apparatus of claim 60, further comprising the profile and recommendation system for applying a filtering constraint by accessing an exclusion constraint.

62. The apparatus of claim 61, further comprising the profile and recommendation system for accessing an exclusion constraint by,
tracking a number of offerings of a selected content item to a selected user; and
excluding further offerings of the selected content item to the selected user in response to reaching a threshold.

63. The apparatus of claim 61, further comprising the profile and recommendation system for accessing an exclusion constraint by receiving a category restriction for a selected user.

64. The apparatus of claim 61, further comprising the profile and recommendation system for accessing an exclusion constraint by determining that a selected content item has previously been selected and received by a selected mobile device of a selected user.

65. The apparatus of claim 64, further comprising the profile and recommendation system for identifying a content item for recommendation that is associated with the previously selected content item.

66. The apparatus of claim 61, further comprising the profile and recommendation system for accessing an exclusion constraint by determining device compatibility of a selected wireless device for a selected content item.

67. The apparatus of claim 59, further comprising the profile and recommendation system for selecting a subset of recommendations by applying a filtering constraint by determining a confidence level of a plurality of recommendations of selected content items and applying a weighting factor in accordance to the confidence level.

68. The apparatus of claim 67, further comprising the profile and recommendation system for sorting the plurality of recommendations in accordance to the weighting factor.

69. The apparatus of claim 59, further comprising the profile and recommendation system for immediate updating of behavior data for a selected user of a wireless device based upon user interaction with presented offerings of recommendations.

70. The apparatus of claim 59, further comprising the profile and recommendation system for associating a selected user of a wireless device with a group of users and selecting recommendations based upon the group association.

71. The apparatus of claim 59, further comprising the profile and recommendation system for accessing attribute data and behavior data consisting of call data, date of birth, gender, prior purchases, expressions of interest, expressions of disinterest, spending pattern, mobile device type, current geographical location, call frequency, or other user metadata
